(19) United States
(12) Patent Application Publication
(10) Pub. No.: US 2024/0146457 A1
(43) Pub. Date: May 2, 2024

(54) METHOD AND APPARATUS FOR SS/PBCH BLOCK FOR NARROW CHANNEL BANDWIDTH

(71) Applicant: Samsung Electronics Co., Ltd., Suwon-si (KR)

(72) Inventors: Hongbo Si, Allen, TX (US); Aristides Papasakellariou, Houston, TX (US)

(21) Appl. No.: 18/483,440

(22) Filed: Oct. 9, 2023

Related U.S. Application Data
(60) Provisional application No. 63/420,319, filed on Oct. 28, 2022.
(60) Provisional application No. 63/420,940, filed on Oct. 31, 2022.
(60) Provisional application No. 63/428,598, filed on Nov. 29, 2022.
(60) Provisional application No. 63/430,906, filed on Dec. 7, 2022.
(60) Provisional application No. 63/431,248, filed on Dec. 8, 2022.
(60) Provisional application No. 63/439,961, filed on Jan. 19, 2023.
(60) Provisional application No. 63/446,217, filed on Feb. 16, 2023.
(60) Provisional application No. 63/463,775, filed on May 3, 2023.
(60) Provisional application No. 63/468,163, filed on May 22, 2023.
(60) Provisional application No. 63/470,681, filed on Jun. 2, 2023.
(60) Provisional application No. 63/530,834, filed on Aug. 4, 2023.

(51) Int. Cl. H04L 1/00; H04W 56/00

(52) U.S. Cl. CPC H04L 1/0068; H04W 56/0015

(57) ABSTRACT

A user equipment (UE) in a wireless communication system includes a processor. The processor is configured to determine a channel bandwidth for a frequency band in which the wireless communication system operates, and when the channel bandwidth is 3 megahertz (MHz), determine a punctured bandwidth of a synchronization signals and physical broadcast channel (SS/PBCH) block as 144 subcarriers, wherein subcarriers 0 to 47 and subcarriers 192 to 239 are punctured from 240 subcarriers of the SS/PBCH block bandwidth, and all 4 symbols of the SS/PBCH block are punctured. The UE further includes a transceiver operably coupled to the processor. The transceiver is configured to receive the SS/PBCH block based on the punctured bandwidth of the SS/PBCH block.

### CROSS-REFERENCE TO RELATED APPLICATION(S) AND CLAIM OF PRIORITY

This application claims priority under 35 U.S.C. § 119(e) to U.S. Provisional Patent Application No. 63/420,319 filed on Oct. 28, 2022, U.S. Provisional Patent Application No. 63/420,940 filed on Oct. 31, 2022, U.S. Provisional Patent Application No. 63/428,598 filed on Nov. 29, 2022, U.S. Provisional Patent Application No. 63/430,906 filed on Dec. 7, 2022, U.S. Provisional Patent Application No. 63/431,248 filed on Dec. 8, 2022, U.S. Provisional Patent Application No. 63/439,961 filed on Jan. 19, 2023, U.S. Provisional Patent Application No. 63/446,217 filed on Feb. 16, 2023, U.S. Provisional Patent Application No. 63/463,775 filed on May 3, 2023, U.S. Provisional Patent Application No. 63/468,163 filed on May 22, 2023, U.S. Provisional Patent Application No. 63/470,681 filed on Jun. 2, 2023, and U.S. Provisional Patent Application No. 63/530,834 filed on Aug. 4, 2023. The above-identified provisional patent applications are hereby incorporated by reference in their entirety.

### TECHNICAL FIELD

This disclosure relates generally to wireless networks. More specifically, this disclosure relates to methods and apparatuses for SS/PBCH block, for narrow channel bandwidth.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure provides methods and apparatuses for SS/PBCH block, for narrow channel bandwidth.

In one embodiment, a user equipment (UE) in a wireless communication system is provided. The UE includes a processor configured to determine a channel bandwidth for a frequency band in which the wireless communication system operates, and when the channel bandwidth is 3 megahertz (MHz), determine a punctured bandwidth of a synchronization signals and physical broadcast channel (SS/PBCH) block as 144 subcarriers, wherein subcarriers 0 to 47 and subcarriers 192 to 239 are punctured from 240 subcarriers of the SS/PBCH block bandwidth, and all 4 symbols of the SS/PBCH block are punctured. The UE further includes a transceiver operably coupled to the processor. The transceiver is configured to receive the SS/PBCH block based on the punctured bandwidth of the SS/PBCH block.

In another embodiment, a base station (BS) in a wireless communication system is provided. The BS includes a processor configured to determine a channel bandwidth for a frequency band in which the wireless communication system operates, and when the channel bandwidth is 3 MHz, determine a punctured bandwidth of a SS/PBCH block as 144 subcarriers, wherein subcarriers 0 to 47 and subcarriers 192 to 239 are punctured from 240 subcarriers of the SS/PBCH block bandwidth, and all 4 symbols of the SS/PBCH block are punctured. The BS further includes a transceiver operably coupled to the processor. The transceiver is configured to transmit the SS/PBCH block based on the punctured bandwidth of the SS/PBCH block.

In yet another embodiment, a method of a UE in a wireless communication system is provided. The method includes determining a channel bandwidth for a frequency band in which the wireless communication system operates, and when the channel bandwidth is 3 MHz, determining a punctured bandwidth of a SS/PBCH block as 144 subcarriers, wherein subcarriers 0 to 47 and subcarriers 192 to 239 are punctured from 240 subcarriers of the SS/PBCH block bandwidth, and all 4 symbols of the SS/PBCH block are punctured. The method further includes receiving the SS/PBCH block based on the punctured bandwidth of the SS/PBCH block.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The following documents and standards descriptions are hereby incorporated by reference into the present disclosure as if fully set forth herein:
[1] 3GPP TS 38.211 v17.1.0, “NR; Physical channels and modulation.”
[2] 3GPP TS 38.212 v17.1.0, “NR; Multiplexing and channel coding.”
[3] 3GPP TS 38.213 v17.1.0, “NR; Physical layer procedures for control.”
[4] 3GPP TS 38.214 v17.1.0, “NR; Physical layer procedures for data.”
[5] 3GPP TS 38.331 v17.1.0, “NR; Radio Resource Control (RRC) protocol specification.”

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example of REG bundle mapping according to embodiments of the present disclosure;

FIGS. 5A-5B illustrate examples of SS/PBCH blocks with 12 RBs according to embodiments of the present disclosure;

FIGS. 6A-6B illustrate examples of SS/PBCH blocks with 11 RBs according to embodiments of the present disclosure;

FIGS. 7A-7B illustrate examples of SS/PBCH blocks with Y RBs, wherein 12<Y<20 according to embodiments of the present disclosure;

FIG. 8 illustrates examples of slot locations for SS/PBCH block structures having 5 symbols according to embodiments of the present disclosure;

FIG. 9 illustrates examples of slot locations for SS/PBCH block structures having 6 symbols according to embodiments of the present disclosure;

FIG. 10 illustrates an example of truncation of CORESET #0 bandwidth according to embodiments of the present disclosure;

FIG. 11 illustrates an example of no interleaving of CCEs according to embodiments of the present disclosure;

FIG. 12 illustrates an example of reordering of CCES after truncation according to embodiments of the present disclosure;

FIG. 13 illustrates an example of CCE-to-REG mapping using truncated bandwidth according to embodiments of the present disclosure;

FIG. 14 illustrates a UE procedure for determining the CCEs for CORESET #0 and CCEs for PDCCH candidates according to embodiments of the present disclosure;

FIG. 15 illustrates a UE procedure for determining the CCEs for CORESET #0 and CCEs for PDCCH candidates according to embodiments of the present disclosure;

FIG. 16 illustrates a UE procedure for determining the CCEs for CORESET #0 and CCEs for PDCCH candidates according to embodiments of the present disclosure; and

FIG. 17 illustrates a UE procedure for determining a punctured bandwidth of a SS/PBCH according to embodiments of the present disclosure.

### DETAILED DESCRIPTION

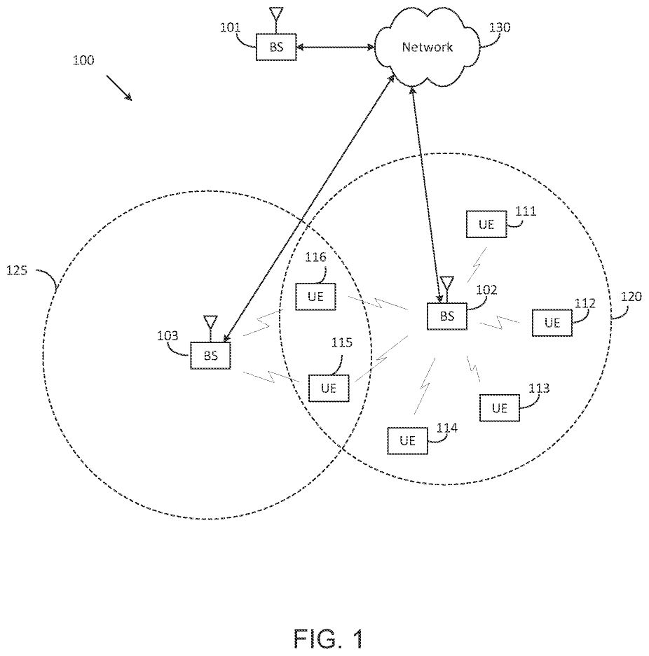

FIGS. 1 through 17, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a SS/PBCH block, for narrow channel bandwidth. In certain embodiments, one or more of the gNBs 101-103 includes circuitry, programing, or a combination thereof, to support a SS/PBCH block, for narrow channel bandwidth in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

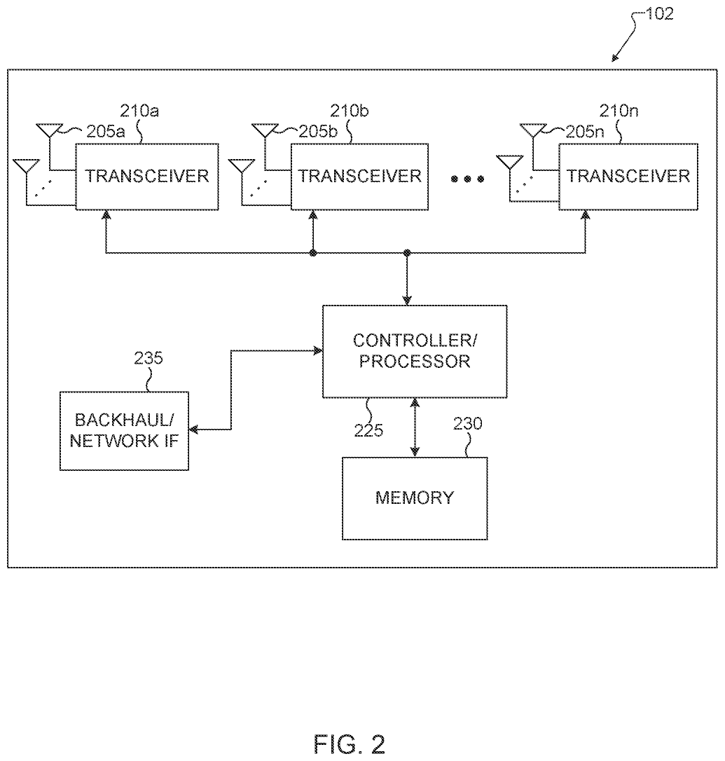

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support a SS/PBCH block for narrow channel bandwidth as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

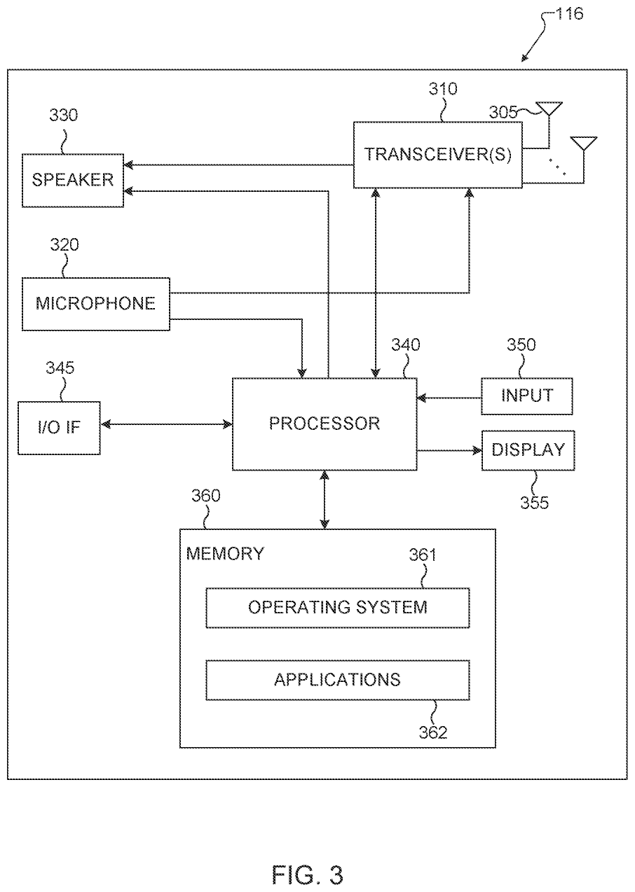

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for a SS/PBCH block for narrow channel bandwidth as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

Since NR Rel-15, the minimum channel bandwidth of supported bands is 5 MHz for FR1, and channel bandwidth smaller than 5 MHz is not supported. Considering to support wide use cases in NR, there is a need to support a channel bandwidth smaller than 5 MHz, e.g. around 3 MHz.

For initial access, the location of a synchronization signals and physical broadcast channel (SS/PBCH) block is determined from a set of default global synchronization channel number (GSCN) values, wherein the GSCN values are designed per subcarrier spacing (SCS) of the SS/PBCH block, and selected based on the minimum channel bandwidth.

Since the minimum channel bandwidth is reduced from 5 MHz, it is possible that the minimum channel bandwidth is smaller than the legacy bandwidth of a SS/PBCH block, e.g. 20 resource blocks (RBs), so enhancement to the SS/PBCH block structure is needed to fit into the channel. The embodiments and examples of this disclosure are applicable to the frequency bands supporting a channel bandwidth smaller than 5 MHz, e.g., channel bandwidth as 3 MHz. One or more examples can be applicable to different frequency bands supporting a channel bandwidth smaller than 5 MHz, e.g., channel bandwidth as 3 MHz.

Moreover, a CORESET #0 can be present for a SS/PBCH block serving as cell-defining purpose, and the CORESET #0 can be located within the minimum channel bandwidth of the channel the same as the channel including the associated SS/PBCH block. Hence, if the minimum channel bandwidth reduces from 5 MHz to a smaller value, the corresponding CORESET #0 configuration may need an enhancement.

The control resource set (CORESET) for monitoring Type0-PDCCH common search space set (e.g., CORESET #0) is located within the minimum channel bandwidth of the channel the same as the channel including the associated SS/PBCH block. Hence, if the minimum channel bandwidth reduces from 5 MHz to a smaller value, the corresponding CORESET #0 configuration may need an enhancement. In NR Rel-15, the minimum configurable number of RBs for CORESET #0 is 24, which cannot fit into a channel with bandwidth smaller than 5 MHz, and some truncation or supporting of a smaller number of RBs for CORESET #0 is needed. In this sense, the control channel element (CCE) needs to be enhanced accordingly.

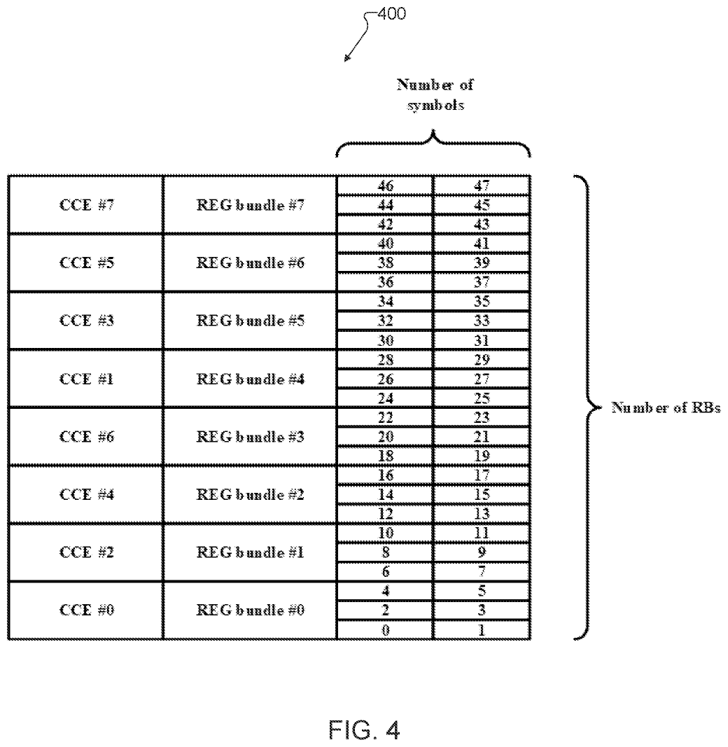

Resource element group (REG) refers to resource elements in a resource block and within one OFDM symbol, and a number (e.g., L_REG) of REGs can formulate a REG bundle. One CORESET can correspond to K=N_BW*N_symb/L_REG REG bundles, wherein N_BW is the number of RBs for CORESET bandwidth, and N_symb is the number of symbols for the CORESET. The K REG bundles are ordered from the lowest to highest frequency with index of 0 to K−1, and are further mapped to control channel elements (CCEs) based on an interleaving function. Resources for PDCCH are selected based on the CCEs, and the number of CCEs selected is according to the aggregation level (AL). An illustration of the REG bundle mapping is shown in FIG. 4.

FIG. 4 illustrates an example 400 of REG bundle mapping according to embodiments of the present disclosure. The embodiment of REG bundle mapping of FIG. 4 is for illustration only. Different embodiments of REG bundle mapping could be used without departing from the scope of this disclosure.

Although FIG. 4 illustrates an example 400 of REG bundle mapping, various changes may be made to FIG. 4. For example, various changes to the number of CCEs, the number of REG bundles, the number of symbols, etc. could be made according to particular needs.

The present disclosure focuses on the design of a SS/PBCH block in a carrier with channel bandwidth narrower than 5 MHz. More precisely, the following aspects are included in the present disclosure:
SS/PBCH block structure with 12 RBS
SS/PBCH block structure with 11 RBS
SS/PBCH block structure with more than 12 RBS
SS/PBCH block time domain pattern
Energy per resource element (EPRE) of SS/PBCH BLOCK

Additionally, the present disclosure focuses on the design of a CORESET #0 configuration in a carrier with channel bandwidth narrower than 5 MHz. More precisely, the following aspects are included in the present disclosure:
CORESET #0 bandwidth smaller than 24 RBs
Frequency domain RB offset
Number of symbols for CORESET #0
Example configuration table
Indication on table to use

Furthermore, the present disclosure focuses on the design of a CCE in CORESET #0, in a carrier with channel bandwidth narrower than 5 MHz. More precisely, the following aspects are included in the present disclosure:
Truncation of CORESET #0 bandwidth
Interleaving of REG bundles
CCE selection for PDCCH candidates
New aggregation level as 6
New number of symbols for CORESET #0 as 4
Example UE procedures

As previously discussed herein, the present disclosure includes the design of a SS/PBCH block in a carrier with channel bandwidth narrower than 5 MHz.

In one embodiment, the bandwidth of a SS/PBCH block can be 12 RBs.

For one example, a primary synchronization signal (PSS) is mapped to one symbol in the SS/PBCH block.

For another example, a secondary synchronization signal (SSS) is mapped to one symbol in the SS/PBCH block.

For yet another example, symbols for a PSS, a SSS, and a PBCH (including a demodulation reference signals [DMRS]) are time division multiplexed (TDMed) in the SS/PBCH block.

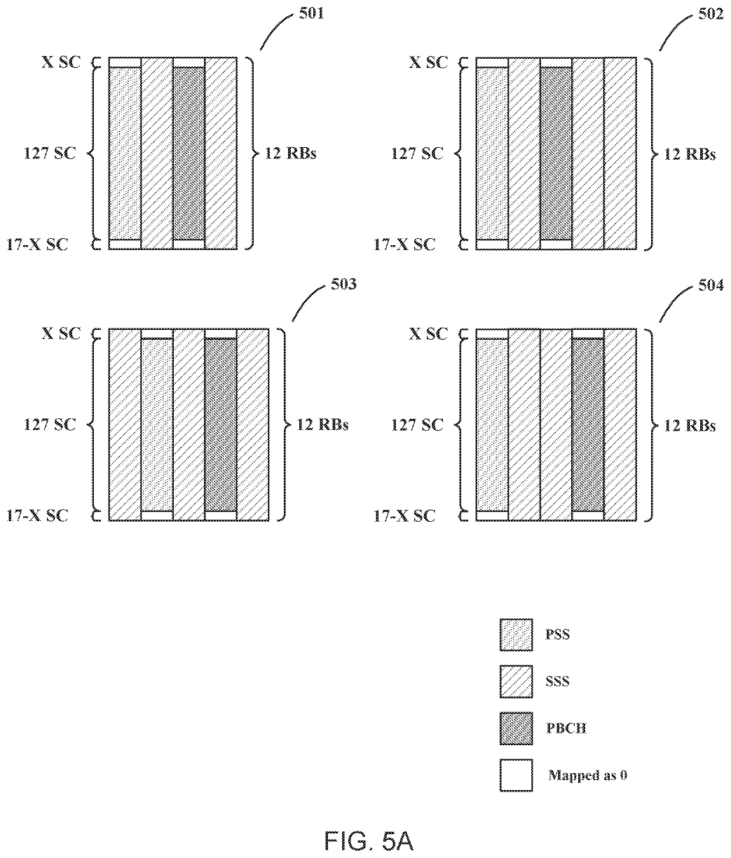

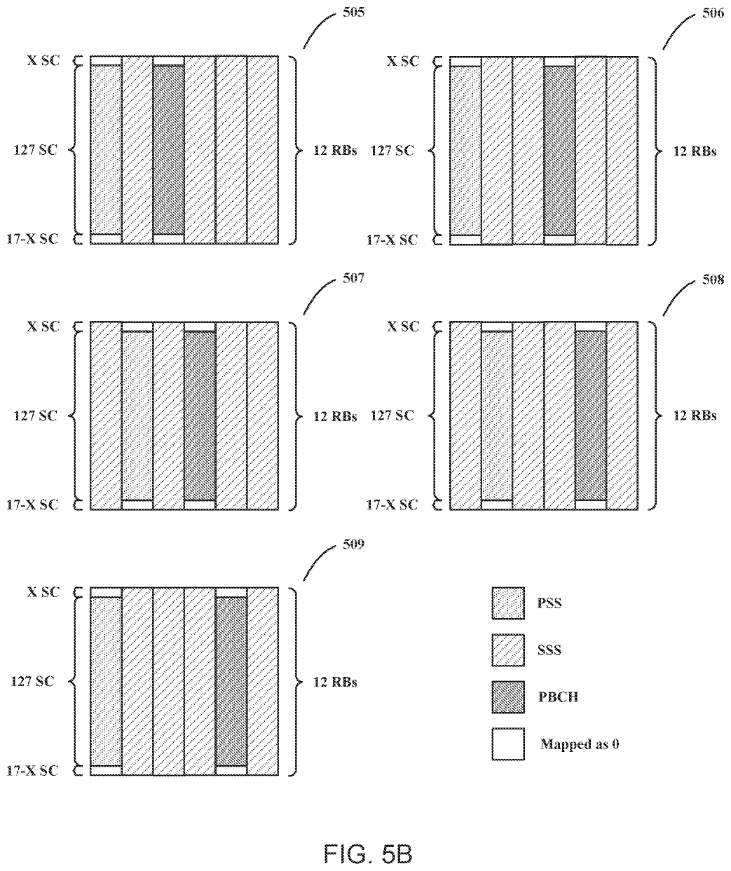

Examples according to this embodiment are shown in FIG. 5A and FIG. 5B, wherein X is a fixed number, e.g. X=8, or X=9.

FIGS. 5A-5B illustrate examples 501-509 of SS/PBCH blocks with 12 RBs (e.g., 144 subcarriers) according to embodiments of the present disclosure. The embodiment of SS/PBCH blocks of FIGS. 5A-5B is for illustration only. Different embodiments of SS/PBCH blocks could be used without departing from the scope of this disclosure.

In one sub-example, for 501 in FIG. 5A, it can be considered as truncated from a legacy SS/PBCH block with a bandwidth of 20 RBs (e.g., 240 subcarriers), wherein the lowest 4 RBs (or lowest 48 subcarriers) and highest 4 RBs (or highest 48 subcarriers) are truncated. For instance, for SS/PBCH block transmission within a channel bandwidth as 3 MHz (or around 3 MHz), the transmitted SS/PBCH block can be a truncated version of the legacy SS/PBCH block structure, wherein the lowest 4 RBs (or lowest 48 subcarriers) and highest 4 RBs (or highest 48 subcarriers) of the legacy SS/PBCH block are not transmitted.

Although FIGS. 5A-5B illustrate examples 501-509 of SS/PBCH blocks with 12 RBs, various changes may be made to FIGS. 5A-5B. For example, various changes to the RBs, the channel bandwidth, the block structure, etc. could be made according to particular needs.

In one embodiment, the bandwidth of a SS/PBCH block can be 11 RBs.

For one example, a PSS is mapped to one symbol in the SS/PBCH block.

For another example, a SSS is mapped to one symbol in the SS/PBCH block.

For yet another example, symbols for a PSS, a SSS, and a PBCH (including a DMRS) are TDMed in the SS/PBCH block.

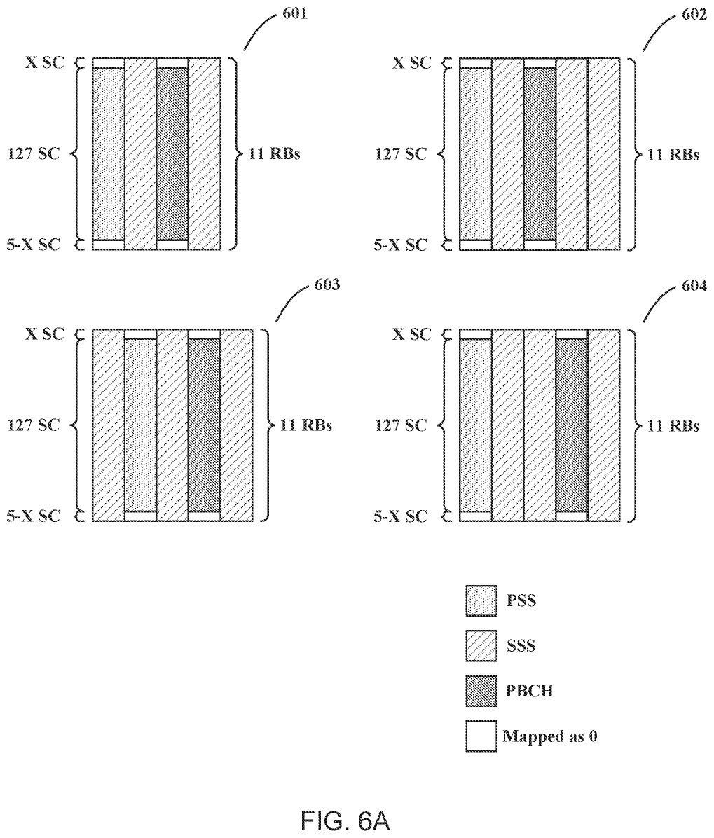

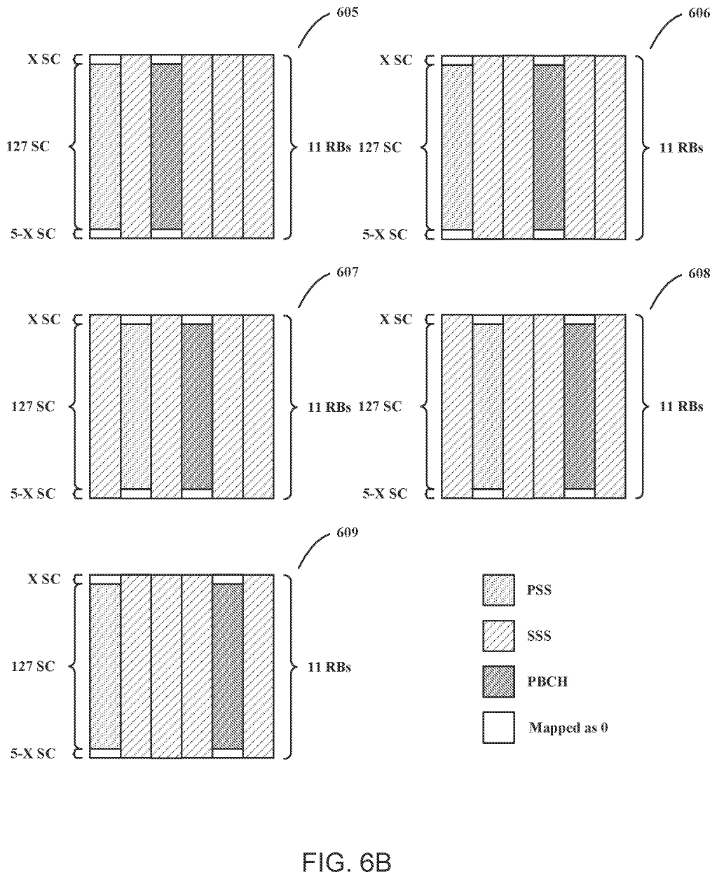

Examples according to this embodiment are shown in FIG. 6A and FIG. 6B, wherein X is a fixed number, e.g. X=2, or X=3.

FIGS. 6A-6B illustrate examples 601-609 of SS/PBCH blocks with 11 RBs according to embodiments of the present disclosure. The embodiment of SS/PBCH blocks of FIGS. 6A-6B is for illustration only. Different embodiments of SS/PBCH blocks could be used without departing from the scope of this disclosure.

In one sub-example, for 601 in FIG. 6A, it can be considered as truncated from a legacy SS/PBCH block with a bandwidth of 20 RBs, wherein the lowest 4.5 RBs (or lowest 54 subcarriers) and highest 4.5 RBs (or highest 54 subcarriers) are truncated. For instance, for SS/PBCH block transmission within a channel bandwidth as 3 MHz (or around 3 MHz), the transmitted SS/PBCH block can be a truncated version of the legacy SS/PBCH block structure, wherein the lowest 4.5 RBs (or lowest 54 subcarriers) and highest 4.5 RBs (or highest 54 subcarriers) of the legacy SS/PBCH block are not transmitted.

Although FIGS. 6A-6B illustrate examples 601-609 of SS/PBCH blocks with 11 RBs, various changes may be made to FIGS. 6A-6B. For example, various changes to the RBs, the channel bandwidth, the block structure, etc. could be made according to particular needs.

In one embodiment, the bandwidth of SS/PBCH block can be Y RBs, wherein 12<Y<20.

For one example, a PSS is mapped to one symbol in the SS/PBCH block.

For another example, a PSS is mapped to RBs in one symbol in the SS/PBCH block, and a PBCH (including a DMRS) can be frequency division multiplexed (FDMed) with the RBs mapped for a SSS.

For yet another example, a SSS is mapped to RBs in one symbol in the SS/PBCH block, and a PBCH (including a DMRS) can be FDMed with the RBs mapped for SSS.

For yet another example, symbols for a PSS, a SSS, and a PBCH (including a DMRS) are TDMed in the SS/PBCH block.

For yet another example, the bandwidth of SS/PBCH block can be determined as Y=12+Z1+Z2, wherein Z1 and Z2 are the bandwidth of PBCH other than the 12 RBs (e.g., for PSS and SSS). In one sub-example, Z1=Z2, such as Z1=Z2=3, and Y=18; or Z1=Z2=2, andY=16; or Z1=Z2=1, and Y=14.

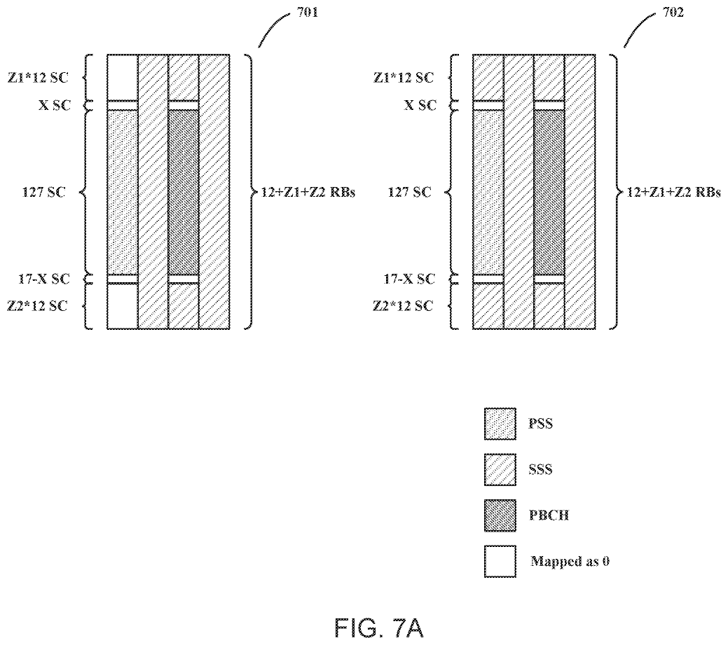

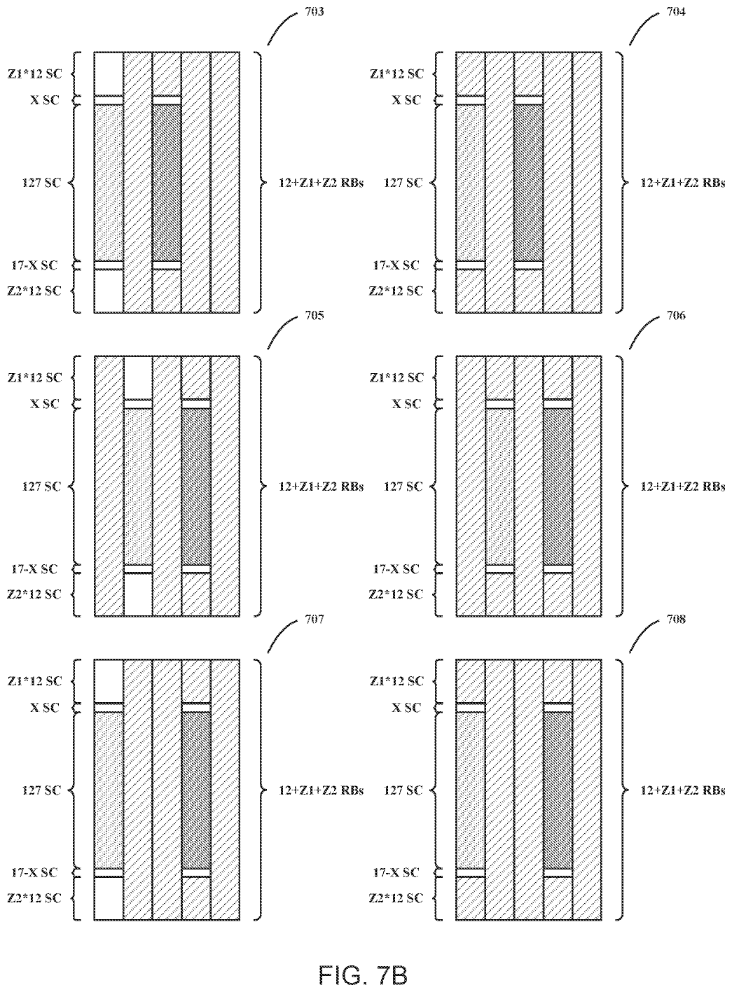

A first set of examples according to this embodiment are shown in FIG. 7A, wherein X is a fixed number, e.g. X=8, or X=9.
In one sub-example, Z1+Z2≥6 in the examples, such as Z1=Z2=3, and Y=18.
In another sub-example, Z1=Z2=2, and Y=16.
In yet another sub-example, Z1=Z2=1, and Y=14.
In yet another sub-example, Z1=1, Z2=2, and Y=15.
In yet another sub-example, Z1=2, Z2=1, and Y=15.

FIGS. 7A-7B illustrate examples 701-708 of SS/PBCH blocks with Y RBs, wherein 12<Y<20 according to embodiments of the present disclosure. The embodiment of SS/PBCH blocks of FIGS. 7A-7B is for illustration only. Different embodiments of SS/PBCH blocks could be used without departing from the scope of this disclosure.

In one sub-example, for 701 in FIG. 7A, it can be considered as truncated from a legacy SS/PBCH block with a bandwidth of 20 RBs, wherein the lowest 4-Z2 RBs (or lowest 12*(4-Z2) subcarriers) and highest 4-Z1 RBs (or highest 12*(4-Z1) subcarriers) are truncated. For instance, for SS/PBCH block transmission within a channel bandwidth as 3 MHz (or around 3 MHz), the transmitted SS/PBCH block can be a truncated version of the legacy SS/PBCH block structure, wherein the lowest 4-Z2 RBs (or lowest 12*(4-Z2) subcarriers) and highest 4-Z1 RBs (or highest 12*(4-Z1) subcarriers) of the legacy SS/PBCH block are not transmitted.

A second set of examples according to this embodiment are shown in FIG. 7B, wherein X is a fixed number, e.g. X=8, or X=9.
In one sub-example, Z1+Z2≥3 in the examples, such as Z1=Z2=2, and Y=16; or Z1=Z2=1.5, and Y=15; or Z1=1, Z2=2, and Y=15; or Z1=2, Z2=1, and Y=15.
In another sub-example, Z1+Z2≥2 in the examples, such as Z1=Z2=1, and Y=14.
In yet another sub-example, Z1=Z2=3, and Y=18.

Although FIGS. 7A-7B illustrate examples 701-708 of SS/PBCH blocks with Y RBs, wherein 12<Y<20, various changes may be made to FIGS. 7A-7B. For example, various changes to the RBs, the channel bandwidth, the block structure, etc. could be made according to particular needs.

In one embodiment, the time domain pattern of a SS/PBCH block within a period can be predefined.

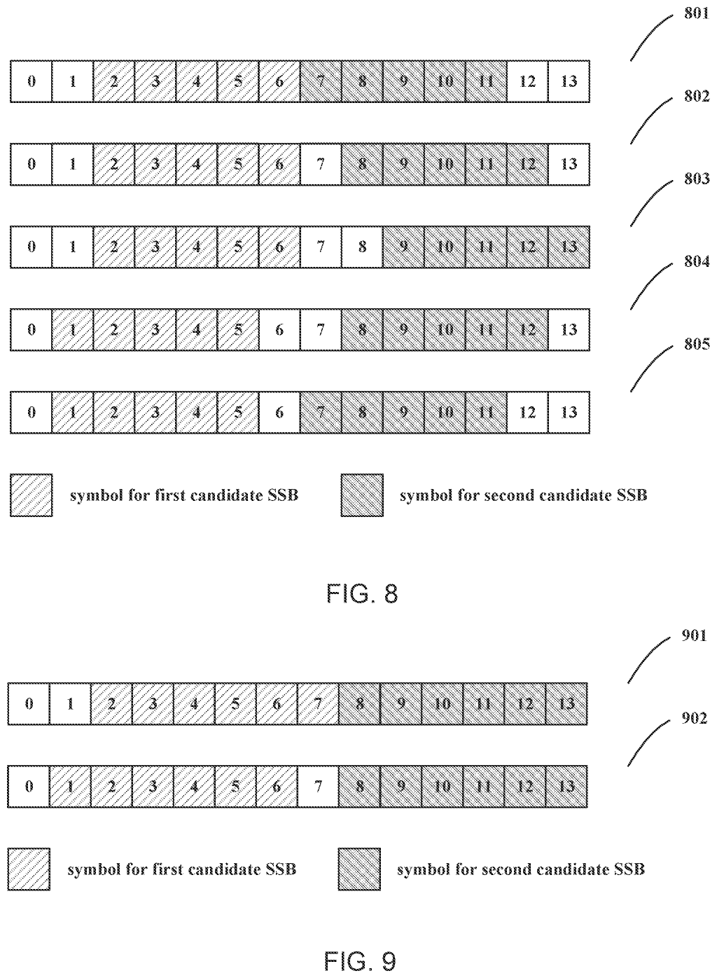

For one example, for the examples of this disclosure with a SS/PBCH block structure having 5 symbols, at least one of the following examples in FIG. 8 can be used to determine the location of the SS/PBCH block within a slot. For this example, the first symbols of the candidate SS/PBCH blocks have indexes of {s1, s2}+14·n, e.g., wherein n=0, 1 if the maximum number of candidate SS/PBCH blocks is 4; or n=0, 1, 2, 3 if the maximum number of candidate SS/PBCH blocks is 8.

FIG. 8 illustrates examples 801-805 of slot locations for SS/PBCH block structures having 5 symbols according to embodiments of the present disclosure. The embodiment of SS/PBCH block structure of FIG. 8 is for illustration only. Different embodiments of SS/PBCH block structure could be used without departing from the scope of this disclosure.

For 801 in FIG. 8, s1=2, and s2=7.

For 802 in FIG. 8, s1=2, and s2=8.

For 803 in FIG. 8, s1=2, and s2=9.

For 804 in FIG. 8, s1=1, and s2=8.

For 805 in FIG. 8, s1=1, and s2=7.

Although FIG. 8 illustrates examples 801-805 of slot locations for SS/PBCH block structures having 5 symbols, various changes may be made to FIG. 8. For example, various changes to the slots, the symbols, the symbol locations in the slots, etc. could be made according to particular needs.

For another example, for the examples of this disclosure with SS/PBCH block structure having 6 symbols, at least one of the following examples in FIG. 9 can be used to determine the location of the SS/PBCH block within a slot. For this example, the first symbols of the candidate SS/PBCH blocks have indexes of {s1, s2}+14·n, e.g., wherein n=0, 1 if the maximum number of candidate SS/PBCH block is 4; or n=0, 1, 2, 3 if the maximum number of candidate SS/PBCH block is 8.

FIG. 9 illustrates examples 901-902 of slot locations for SS/PBCH block structures having 6 symbols according to embodiments of the present disclosure. The embodiment of SS/PBCH block structure of FIG. 9 is for illustration only. Different embodiments of SS/PBCH block structure could be used without departing from the scope of this disclosure.

For 901 in FIG. 9, s1=2, and s2=8.

For 902 in FIG. 9, s1=1, and s2=8.

Although FIG. 9 illustrates examples 901-902 of slot locations for SS/PBCH block structures having 6 symbols, various changes may be made to FIG. 9. For example, various changes to the slots, the symbols, the symbol locations in the slots, etc. could be made according to particular needs.

In one embodiment, the UE can perform measurement based on the elements in the SS/PBCH block. For instance, when the SS/PBCH block has a bandwidth smaller than a legacy SS/PBCH block bandwidth (e.g., 20 RBs), which can be considered as truncated from the legacy SS/PBCH block structure. At least one of the following examples can be applicable for the SS/PBCH block with a bandwidth smaller than legacy SS/PBCH block bandwidth (e.g., 20 RBs).

For one example, the UE assumes that SSS, PBCH DMRS, and PBCH data in the SS/PBCH block have the same EPRE.

For another example, the UE assumes that PBCH DMRS and PBCH data in the SS/PBCH block have the same EPRE, and the ratio of SSS EPRE to PBCH DMRS/data EPRE is P1 dB. For instance, P1=10·log 10(N_RB\hat{ }SSB/20).

For yet another example, the UE may assume that the ratio of PSS EPRE to SSS EPRE in a SS/PBCH block is 0 dB. For instance, this example can be applicable to the case that the bandwidth of a SS/PBCH block is 12 RBs. For another instance, this example can be applicable to the case that the bandwidth of a SS/PBCH block is 11 RBs.

For yet another example, the UE may assume that the ratio of PSS EPRE to SSS EPRE in a SS/PBCH block is either 0 dB or P2 dB. For instance, P2=10·log 10 (N_RB\hat{ } SSB*12/127).

For yet another example, the UE may assume that the ratio of PSS EPRE to SSS EPRE in a SS/PBCH block is either P1 dB or 3+P1 dB. For instance, P1=10·log 10(N_RB\hat{ } SSB/20).

Example values of P1 and P2 are shown in Table 1.

TABLE 1
Example values of P1 and P2.

| N_RB\hat{ }SSB | P1 | P2 |
|---|---|---|
| 11 | 0.17 | −2.60 |
| 12 | 0.55 | −2.22 |
| 13 | 0.89 | −1.87 |
| 14 | 1.22 | −1.55 |
| 15 | 1.51 | −1.25 |
| 16 | 1.79 | −0.97 |
| 17 | 2.06 | −0.71 |
| 18 | 2.31 | −0.46 |
| 19 | 2.54 | −0.22 |

In one embodiment, for a SS/PBCH block structure with 4 symbols and a bandwidth as N_RB\hat{ }SSB RBs (e.g., 501 in FIG. 5 with N_RB\hat{ }SSB=12, or 601 in FIG. 6 with N_RB\hat{ }SSB=11, or 701 in FIG. 7 with N_RB\hat{ }SSB=Y), the number of subcarriers mapped for PBCH data and its DMRS can be given by [(max(N_RB\hat{ }SSB, 12)-12)·3+min(N_RB\hat{ }SSB, 12)·2]·12, or given by Table 2.

TABLE 2
Number of subcarriers for PBCH
and its DMRS in a SS/PBCH block

| | Number | Number | Number | Number |
|---|---|---|---|---|
| | of sub- | of sub- | of sub- | of sub- |
| | carriers | carriers | carriers | carriers |
| | for SSB | for PBCH | for PBCH | for PBCH |
| | bandwidth | and its | data | DMRS |
| N_RB\hat{ }SSB | (N\hat{ }SSB) | DMRS | (N\hat{ }PBCH) | (N\hat{ }DMRS) |
| 11 | 132 | 264 | 198 | 66 |
| 12 | 144 | 288 | 216 | 72 |
| 13 | 156 | 324 | 243 | 81 |
| 14 | 168 | 360 | 270 | 90 |
| 15 | 180 | 396 | 297 | 99 |
| 16 | 192 | 432 | 324 | 108 |
| 17 | 204 | 468 | 351 | 117 |
| 18 | 216 | 504 | 378 | 126 |
| 19 | 228 | 540 | 405 | 135 |

In one example, for the SS/PBCH block structure with 4 symbols and a bandwidth as N_RB\hat{ }SSB RBs, the channel coding and rate matching can be as in the legacy SS/PBCH block (e.g., the rate matching output sequence length is E=864), and DMRS sequence generation can be also as in the legacy SS/PBCH block (e.g., with length 144), and part of the subcarriers within the 240 subcarriers in the legacy SS/PBCH block (e.g., the subcarriers out of the N_RB\hat{ }SSB RBs) are not transmitted, for a channel with channel bandwidth smaller than 5 MHz (e.g., 3 MHz or approximate 3 MHz). For instance, the not transmitted subcarriers can be zero values for the ones in the symbol mapped for PSS, and can be PBCH data or PBCH DMRS for the ones in the symbols other than PSS.

For one sub-example, when N_RB\hat{ }SSB=19, for a channel with channel bandwidth smaller than 5 MHz (e.g., 3 MHz or approximate 3 MHz), the subcarriers 0 to 11 for all 4 symbols of the SS/PBCH block are not transmitted.

For another sub-example, when N_RB\hat{ }SSB=19, for a channel with channel bandwidth smaller than 5 MHz (e.g., 3 MHz or approximate 3 MHz), the subcarriers 228 to 239 for all 4 symbols of the SS/PBCH block are not transmitted.

For yet another sub-example, when N_RB\hat{ }SSB=19, for a channel with channel bandwidth smaller than 5 MHz (e.g., 3 MHz or approximate 3 MHz), the subcarriers 0 to 5 and subcarriers 234 to 239 for all 4 symbols of the SS/PBCH block are not transmitted.

For yet another sub-example, when N_RB\hat{ }SSB=18, for a channel with channel bandwidth smaller than 5 MHz (e.g., 3 MHz or approximate 3 MHz), the subcarriers 0 to 23 for all 4 symbols of the SS/PBCH block are not transmitted.

For yet another sub-example, when N_RB\hat{ }SSB=18, for a channel with channel bandwidth smaller than 5 MHz (e.g., 3 MHz or approximate 3 MHz), the subcarriers 216 to 239 for all 4 symbols of the SS/PBCH block are not transmitted.

For yet another sub-example, when N_RB\hat{ }SSB=18, for a channel with channel bandwidth smaller than 5 MHz (e.g., 3 MHz or approximate 3 MHz), the subcarriers 0 to 11 and subcarriers 228 to 239 for all 4 symbols of the SS/PBCH block are not transmitted.

For yet another sub-example, when N_RB\hat{ }SSB=17, for a channel with channel bandwidth smaller than 5 MHz (e.g., 3 MHz or approximate 3 MHz), the subcarriers 0 to 35 for all 4 symbols of the SS/PBCH block are not transmitted.

For yet another sub-example, when N_RB\hat{ }SSB=17, for a channel with channel bandwidth smaller than 5 MHz (e.g., 3 MHz or approximate 3 MHz), the subcarriers 204 to 239 for all 4 symbols of the SS/PBCH block are not transmitted.

For yet another sub-example, when N_RB\hat{ }SSB=17, for a channel with channel bandwidth smaller than 5 MHz (e.g., 3 MHz or approximate 3 MHz), the subcarriers 0 to 17 and subcarriers 222 to 239 for all 4 symbols of the SS/PBCH block are not transmitted.

For yet another sub-example, when N_RB\hat{ }SSB=16, for a channel with channel bandwidth smaller than 5 MHz (e.g., 3 MHz or approximate 3 MHz), the subcarriers 0 to 47 for all 4 symbols of the SS/PBCH block are not transmitted.

For yet another sub-example, when N_RB\hat{ }SSB=16, for a channel with channel bandwidth smaller than 5 MHz (e.g., 3 MHz or approximate 3 MHz), the subcarriers 192 to 239 for all 4 symbols of the SS/PBCH block are not transmitted.

For yet another sub-example, when N_RB\hat{ }SSB=16, for a channel with channel bandwidth smaller than 5 MHz (e.g., 3 MHz or approximate 3 MHz), the subcarriers 0 to 23 and subcarriers 216 to 239 for all 4 symbols of the SS/PBCH block are not transmitted.

For yet another sub-example, when N_RB\hat{ }SSB=15, for a channel with channel bandwidth smaller than 5 MHz (e.g., 3 MHz or approximate 3 MHz), the subcarriers 0 to 59 for all 4 symbols of the SS/PBCH block are not transmitted.

For yet another sub-example, when N_RB\hat{ }SSB=15, for a channel with channel bandwidth smaller than 5 MHz (e.g., 3 MHz or approximate 3 MHz), the subcarriers 180 to 239 for all 4 symbols of the SS/PBCH block are not transmitted.

For yet another sub-example, when N_RB\hat{ }SSB=15, for a channel with channel bandwidth smaller than 5 MHz (e.g., 3 MHz or approximate 3 MHz), the subcarriers 0 to 29 and subcarriers 210 to 239 for all 4 symbols of the SS/PBCH block are not transmitted.

For yet another sub-example, when N_RB\hat{ }SSB=14, for a channel with channel bandwidth smaller than 5 MHz (e.g., 3 MHz or approximate 3 MHz), the subcarriers 0 to 71 for all 4 symbols of the SS/PBCH block are not transmitted.

For yet another sub-example, when N_RB\hat{ }SSB=14, for a channel with channel bandwidth smaller than 5 MHz (e.g., 3 MHz or approximate 3 MHz), the subcarriers 168 to 239 for all 4 symbols of the SS/PBCH block are not transmitted.

For yet another sub-example, when N_RB\hat{ }SSB=14, for a channel with channel bandwidth smaller than 5 MHz (e.g., 3 MHz or approximate 3 MHz), the subcarriers 0 to 35 and subcarriers 204 to 239 for all 4 symbols of the SS/PBCH block are not transmitted.

For yet another sub-example, when N_RB\hat{ }SSB=13, for a channel with channel bandwidth smaller than 5 MHz (e.g., 3 MHz or approximate 3 MHz), the subcarriers 0 to 83 for all 4 symbols of the SS/PBCH block are not transmitted.

For yet another sub-example, when N_RB\hat{ }SSB=13, for a channel with channel bandwidth smaller than 5 MHz (e.g., 3 MHz or approximate 3 MHz), the subcarriers 156 to 239 for all 4 symbols of the SS/PBCH block are not transmitted.

For yet another sub-example, when N_RB\hat{ }SSB=13, for a channel with channel bandwidth smaller than 5 MHz (e.g., 3 MHz or approximate 3 MHz), the subcarriers 0 to 41 and subcarriers 198 to 239 for all 4 symbols of the SS/PBCH block are not transmitted.

For yet another sub-example, when N_RB\hat{ }SSB=12, for a channel with channel bandwidth smaller than 5 MHz (e.g., 3 MHz or approximate 3 MHz), the subcarriers 0 to 95 for all 4 symbols of the SS/PBCH block are not transmitted.

For yet another sub-example, when N_RB\hat{ }SSB=12, for a channel with channel bandwidth smaller than 5 MHz (e.g., 3 MHz or approximate 3 MHz), the subcarriers 144 to 239 for all 4 symbols of the SS/PBCH block are not transmitted.

For yet another sub-example, when N_RB\hat{ }SSB=12 (e.g., 144 subcarriers), for a channel with channel bandwidth smaller than 5 MHz (e.g., 3 MHz or approximate 3 MHz), the subcarriers 0 to 47 and subcarriers 192 to 239 for all 4 symbols of the SS/PBCH block are not transmitted (e.g., punctured).

For yet another sub-example, when N_RB\hat{ }SSB=11, for a channel with channel bandwidth smaller than 5 MHz (e.g., 3 MHz or approximate 3 MHz), the subcarriers 0 to 107 for all 4 symbols of the SS/PBCH block are not transmitted.

For yet another sub-example, when N_RB\hat{ }SSB=11, for a channel with channel bandwidth smaller than 5 MHz (e.g., 3 MHz or approximate 3 MHz), the subcarriers 132 to 239 for all 4 symbols of the SS/PBCH block are not transmitted.

For yet another sub-example, when N_RB\hat{ }SSB=11, for a channel with channel bandwidth smaller than 5 MHz (e.g., 3 MHz or approximate 3 MHz), the subcarriers 0 to 53 and subcarriers 186 to 239 for all 4 symbols of the SS/PBCH block are not transmitted.

In another example, for the SS/PBCH block structure with 4 symbols and a bandwidth as N_RB\hat{ }SSB RBs, the rate matching output sequence length for PBCH can be E=N\hat{ }PBCH*2 (wherein N\hat{ }PBCH can be determined from Table 2), and the PBCH DMRS sequence length can be N_DMRS (wherein N\hat{ }DMRS can be determined from Table 2), when transmitted for a channel with channel bandwidth smaller than 5 MHz (e.g., 3 MHz or approximate 3 MHz). The mapping of resource elements for PBCH date shall be in increasing order of first the subcarrier index and then the symbol index.

In one embodiment, in an initial cell search, the UE searches the frequency location of the SS/PBCH block according to a synchronization raster entry. At least one example can be applicable to frequency band(s) supporting a channel bandwidth smaller than 5 MHz (e.g., 3 MHz or approximate 3 MHz). Different examples can be applicable to different frequency band(s) supporting a channel bandwidth smaller than 5 MHz (e.g., 3 MHz or approximate 3 MHz).

For one example, the synchronization raster entries for the frequency band(s) supporting a channel bandwidth smaller than 5 MHz (e.g., 3 MHz or approximate 3 MHz) can be not overlapping with the synchronization raster entries for the frequency band(s) not supporting a channel bandwidth smaller than 5 MHz (e.g., 3 MHz or approximate 3 MHz).

For one example, the synchronization raster entries for the frequency band(s) supporting a channel bandwidth smaller than 5 MHz (e.g., 3 MHz or approximate 3 MHz) can be with a uniform interval of 100 kHz, e.g., given by X*100 kHz, wherein X is an integer.

For another example, the synchronization raster entries for the frequency band(s) supporting a channel bandwidth smaller than 5 MHz (e.g., 3 MHz or approximate 3 MHz) can be with a cluster structure, wherein each cluster has 3 entries with a uniform interval of 100 kHz, and the interval between the center entries of neighboring clusters is 800 kHz, e.g., given by X*800 kHz+Y*100 kHz, where X is an integer, and Yϵ{0, 1, 2} or Yϵ{−1, 0, 1}.

For yet another example, the synchronization raster entries for the frequency band(s) supporting a channel bandwidth smaller than 5 MHz (e.g., 3 MHz or approximate 3 MHz) can be with a cluster structure, wherein each cluster has 3 entries with a uniform interval of 100 kHz, and the interval between the center entries of neighboring clusters is 800 kHz, e.g., given by Z+X*800 kHz+Y*100 kHz, where X is an integer, Z is an offset frequency (or starting frequency), and Yϵ{0, 1, 2} or Yϵ{−1, 0, 1}.

For yet another example, the synchronization raster entries for the frequency band(s) supporting a channel bandwidth smaller than 5 MHz (e.g., 3 MHz or approximate 3 MHz) can be with a cluster structure, wherein each cluster has 3 entries with a uniform interval of 100 kHz, and the interval between the center entries of neighboring clusters is 600 kHz, e.g., given by X*600 kHz+Y*100 kHz, where X is an integer, and Yϵ{0, 1, 2} or Yϵ{−1, 0, 1}.

For yet another example, the synchronization raster entries for the frequency band(s) supporting a channel bandwidth smaller than 5 MHz (e.g., 3 MHz or approximate 3 MHz) can be with a cluster structure, wherein each cluster has 3 entries with a uniform interval of 100 kHz, and the interval between the center entries of neighboring clusters is 600 kHz, e.g., given by Z+X*600 kHz+Y*100 kHz, where X is an integer, Z is an offset frequency (or starting frequency), and Yϵ{0, 1, 2} or Yϵ{−1, 0, 1}.

In one embodiment, a UE can expect to receive and/or measure a channel state information (CSI)-reference signal (RS) resource with a number of RBs (as the bandwidth of the CSI-RS) smaller than 24 RBs.

For one example, the CSI-RS can be used for mobility/RRM purpose. For instance, the CSI-RS configuration is provided by RRC parameter CSI-RS-CellMobility.

For one example, the CSI-RS based measurement with a number of RBs smaller than 24 RBs is applicable only for the band or channel with a channel bandwidth smaller than 5 MHz (e.g., 3 MHz or approximately 3 MHz).

For one example, the number of RBs for CSI-RS can be 12 RBs.

For another example, the number of RBs for CSI-RS can be 15 RBs.

For one example, the number of RBs smaller than 24 RBs can be explicitly provided by the RRC parameter. For instance, comparing to legacy candidate values for the RRC parameter nrofPRBs in CSI-RS-CellMobility, at least one new candidate value can be added as “size12” and/or “size15”.

For another example, the UE can be provided with a number of RBs no smaller than 24 RBs (e.g., using the legacy candidate values), and the UE performs CSI-RS based radio resource management (RRM) measurement according to the RBs confined in the carrier or channel or BWP (e.g., active BWP).

For yet another example, the UE can be provided with a number of RBs no smaller than 24 RBs (e.g., using the legacy candidate values), and the UE performs CSI-RS based RRM measurement according to the number of RBs smaller than 24 RBs (e.g., 12 RBs or 15 RBs) for the band or channel with a channel bandwidth smaller than 5 MHz (e.g., 3 MHz or approximately 3 MHz).

As previously discussed herein, the present disclosure includes the design of a CORESET #0 configuration in a carrier with channel bandwidth narrower than 5 MHz.

In one embodiment, a configuration of CORESET #0 with bandwidth smaller than 24 RBs can be supported. In one instance, the CORESET #0 bandwidth smaller than 24 RBs can be explicitly configured in a row in a table (e.g., a new table different from legacy table). In another instance, the CORESET #0 bandwidth smaller than 24 RBs can be determined based a configuration in a row in the table indicated by a master information block (MIB) (e.g., a configuration with CORESET #0 bandwidth as 24 RBs), such as performing some truncation to achieve smaller than 24 RBs.

In one example, the CORESET #0 bandwidth can be an integer multiple of 6. For one instance, a configuration of CORESET #0 with bandwidth as 18 RBs can be supported. For another instance, a configuration of CORESET #0 with bandwidth as 12 RBs can be supported.

In another example, the CORESET #0 bandwidth can be an integer multiple of 3, when the number of symbols for CORESET #0 is 2, or at least 2 (e.g., 3 symbols). For one instance, a CORESET #0 with bandwidth as 21 RBs can be supported. For another instance, a CORESET #0 with bandwidth as 18 RBs can be supported. For yet another instance, a CORESET #0 with bandwidth as 15 RBs can be supported. For yet another instance, a CORESET #0 with bandwidth as 12 RBs can be supported.

In yet another example, the CORESET #0 bandwidth can be an integer multiple of 2, when the number of symbols for CORESET #0 is 3, or at least 3. For one instance, a configuration of CORESET #0 with bandwidth as 22 RBs can be supported. For another instance, a configuration of CORESET #0 with bandwidth as 20 RBs can be supported. For yet another instance, a configuration of CORESET #0 with bandwidth as 18 RBs can be supported. For yet another instance, a configuration of CORESET #0 with bandwidth as 16 RBs can be supported. For yet another instance, a configuration of CORESET #0 with bandwidth as 14 RBs can be supported. For yet another instance, a configuration of CORESET #0 with bandwidth as 12 RBs can be supported.

In one embodiment, the number of symbols for CORESET #0 can be configured as part of the CORESET #0 configuration.

For one example, the number of symbols for CORESET #0 can be 2.

For one example, the number of symbols for CORESET #0 can be 3.

For another example, the number of symbols for CORESET #0 can be 4, e.g., when the bandwidth of CORESET #0 is smaller than 24, e.g., BW_CORESET=12 or 18.

In one embodiment, the CORESET #0 bandwidth and the number of symbols for CORESET #0 can be jointly considered. For one instance, the product of the CORESET #0 bandwidth and the number of symbols for CORESET #0 can be a multiple of 12.

For one example, the CORESET #0 bandwidth as 16 and the number of symbols for CORESET #0 as 3 can be supported. In one further consideration, this example can be supported for the channel bandwidth is at least 16 RBs.

For another example, the CORESET #0 bandwidth as 12 and the number of symbols for CORESET #0 as 3 can be supported.

For yet another example, the CORESET #0 bandwidth as 12 and the number of symbols for CORESET #0 as 2 can be supported.

For yet another example, the CORESET #0 bandwidth as 12 and the number of symbols for CORESET #0 as 1 can be supported.

In one embodiment, for a supported CORESET #0 bandwidth, there can be at least one configurable frequency domain RB offset associated with the CORESET #0 bandwidth, wherein the frequency domain RB offset is from the smallest RB index of the CORESET for Type0-PDCCH CSS set to the smallest RB index of the common RB overlapping with the first RB of the corresponding SS/PBCH block. For instance, for a channel bandwidth of 3 MHz, and/or for frequency band(s) with minimum channel bandwidth smaller than 5 MHz (e.g., as 3 MHz), the corresponding SS/PBCH block is one with truncated bandwidth, e.g., truncated from 20 RBs to 12 RBs.

In one embodiment the CORESET #0 is configured according to at least one of the examples in Table 3, wherein BW_SSB is the bandwidth of SS/PBCH block in number of RBs, and BW_CORESET is the bandwidth of CORESET #0 (e.g., as described in the examples of this disclosure).

TABLE 3
Example frequency domain RB offset(s)
associated with a CORESET#0 bandwidth.

| Exam- | CORESET#0 BW | |
|---|---|---|
| ple # | (RB) | Frequency domain RB offset(s) |
| 1 | BW_CORESET | 0, floor((BW_CORESET − BW_SSB)/2), |
| | | BW_CORESET − BW_SSB |
| 2 | BW_CORESET | 0, ceil((BW_CORESET − BW_SSB)/2), |
| | | BW_CORESET − BW_SSB |
| 3 | BW_CORESET | 0, BW_CORESET − BW_SSB |
| 4 | BW_CORESET | 0 |
| 5 | BW_CORESET | 0, 1, . . . , BW_CORESET − BW_SSB |
| 6 | BW_CORESET | 0, −1, . . . , BW_CORESET − BW_SSB |
| 7 | BW_CORESET | (BW_CORESET − BW_SSB)/2 |

In one embodiment, the SCS of the CORESET for Type0-PDCCH CSS set can be the same as the SCS of the associated SS/PBCH block.

For one example, for frequency band(s) with minimum channel bandwidth smaller than 5 MHz (e.g., 3 MHz), and/or for channel bandwidth as 3 MHz, the SCS of the CORESET for Type0-PDCCH CSS set can be fixed as 15 kHz (e.g., the SCS of the associated SS/PBCH block is also 15 kHz).

For another example, for a frequency band with minimum channel bandwidth smaller than 5 MHz (e.g., 3 MHz), the UE expects subCarrierSpacingCommon=‘scs15or60’.

In one embodiment, the configuration table for CORESET #0, wherein the SS/PBCH block SCS and CORESET #0 SCS are both 15 kHz, can use a different configuration table from the legacy table (wherein the legacy table is for minimum channel bandwidth as 5 MHz or 10 MHz), when the frequency band(s) is with minimum channel bandwidth smaller than 5 MHz (e.g., 3 MHz), and/or the channel bandwidth is 3 MHz. The UE can determine the SS/PBCH block and CORESET #0 multiplexing pattern, the number of RBs for CORESET #0 bandwidth, the number of symbols for CORESET #0, and the RB offset between SS/PBCH block and the CORESET #0, according to the indication of a configuration in the configuration table for CORESET #0. The RB offset can be defined with respect to the SCS of the CORESET for Type0-PDCCH CSS set from the smallest RB index of the CORESET for Type0-PDCCH CSS set to the smallest RB index of the common RB overlapping with the first RB of the corresponding SS/PBCH block, wherein the SS/PBCH block is truncated from the legacy SS/PBCH block such that its transmission bandwidth is smaller than 20 RBs (e.g., 12 RBs). In the examples of this disclosure for CORESET #0 configurations, empty rows mean reserved code points.

In one example, the table can be indicated using 5 bits. The 5 bits includes 4 bits from searchSpaceZero, and 1 another bit from the content of PBCH.
In one instance, the 1 another bit can be subCarrierSpacingCommon.
In another instance, the 1 another bit can be spare.
In yet another instance, the 1 another bit can be ā_{Ā+5}.
In yet another instance, the 1 another bit can be ā_{Ā+6}.
In yet another instance, the 1 another bit can be ā_{Ā+7}.

An example a table for CORESET #0 configuration using 5 bits is shown in Table 4.

TABLE 4
Example set of resource blocks and slot symbols of CORESET for
Type0-PDCCH search space set when {SS/PBCH block, PDCCH}
SCS is {15, 15} kHz for frequency bands with minimum
channel bandwidth smaller than 5 MHz (e.g., 3 MHz).

| | SS/PBCH block | | | |
|---|---|---|---|---|
| | and CORESET | | | |
| | multiplexing | | Number of | |
| Index | pattern | Number of RBs | Symbols | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | 48 | 3 | 12 |
| 11 | 1 | 48 | 3 | 16 |
| 12 | 1 | 96 | 1 | 38 |
| 13 | 1 | 96 | 2 | 38 |
| 14 | 1 | 96 | 3 | 38 |
| 15 | 1 | BW_CORESET | 2 | 0 |
| 16 | 1 | BW_CORESET | 2 | floor((BW_CORESET − |
| | | | | BW_SSB)/2) |
| 17 | 1 | BW_CORESET | 2 | BW_CORESET − |
| | | | | BW_SSB |
| 18 | 1 | BW_CORESET | 3 | 0 |
| 19 | 1 | BW_CORESET | 3 | floor((BW_CORESET − |
| | | | | BW_SSB)/2) |
| 20 | 1 | BW_CORESET | 3 | BW_CORESET − |
| | | | | BW_SSB |
| 21 | 1 | BW_CORESET | 4 | 0 |
| 22 | 1 | BW_CORESET | 4 | floor((BW_CORESET − |
| | | | | BW_SSB)/2) |
| 23 | 1 | BW_CORESET | 4 | BW_CORESET − |
| | | | | BW_SSB |
| 24 | | | | |
| 25 | | | | |
| 26 | | | | |
| 27 | | | | |
| 28 | | | | |
| 29 | | | | |
| 30 | | | | |
| 31 | | | | |

In another example, one bit in PBCH content is used to extend the legacy configuration table and a new table will be used wherein the new table has 16 rows. An example of the extended table is shown in Table 5.
In one instance, the 1 bit for extension can be subCarrierSpacingCommon.
In another instance, the 1 bit for extension can be spare.
In yet another instance, the 1 bit for extension can be ā_{Ā+5}.
In yet another instance, the 1 bit for extension can be ā_{Ā+6}.
In yet another instance, the 1 bit for extension can be ā_{Ā+7}.

TABLE 5
Example of the extended table for set of resource blocks and slot symbols
of CORESET for Type0-PDCCH search space set when {SS/PBCH block, PDCCH}
SCS is {15, 15} kHz for frequency bands with minimum channel bandwidth
smaller than 5 MHz (e.g., 3 MHz), and/or the channel bandwidth is 3 MHz.

| | SS/PBCH block | | | |
|---|---|---|---|---|
| | and CORESET | | Number of | |
| Index | multiplexing pattern | Number of RBs | Symbols | Offset (RBs) |
| 0 | 1 | BW_CORESET | 2 | 0 |
| 1 | 1 | BW_CORESET | 2 | floor((BW_CORESET − |
| | | | | BW_SSB)/2) |
| 2 | 1 | BW_CORESET | 2 | BW_CORESET − |
| | | | | BW_SSB |
| 3 | 1 | BW_CORESET | 3 | 0 |
| 4 | 1 | BW_CORESET | 3 | floor((BW_CORESET − |
| | | | | BW_SSB)/2) |
| 5 | 1 | BW_CORESET | 3 | BW_CORESET − |
| | | | | BW_SSB |
| 6 | 1 | BW_CORESET | 4 | 0 |
| 7 | 1 | BW_CORESET | 4 | floor((BW_CORESET − |
| | | | | BW_SSB)/2) |
| 8 | 1 | BW_CORESET | 4 | BW_CORESET − |
| | | | | BW_SSB |
| 9 | | | | |
| 10 | | | | |
| 11 | | | | |
| 12 | | | | |
| 13 | | | | |
| 14 | | | | |
| 15 | | | | |

In another example, the table can be indicated using 4 bits (e.g., searchSpaceZero), but the content of the table can be different from the legacy table. An example can be shown in Table 6 to Table 19. In one sub-example, a subset of the configurations in Table 6 to Table 19 are supported, e.g., the configurations corresponding to CORESET #0 bandwidth as 12 RBs and number of symbols for CORESET #0 as 3 are not supported.

TABLE 6
Example set of resource blocks and slot symbols of CORESET for Type0-
PDCCH search space set when {SS/PBCH block, PDCCH} SCS is
{15, 15} kHz for frequency bands with minimum channel bandwidth
smaller than 5 MHz (e.g., 3 MHz), and/or the channel bandwidth is 3 MHz.

| | SS/PBCH block | | | |
|---|---|---|---|---|
| | and CORESET | | Number of | |
| Index | multiplexing pattern | Number of RBs | Symbols | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | BW_CORESET | 2 | 0 |
| 11 | 1 | BW_CORESET | 2 | floor((BW_CORESET − |
| | | | | BW_SSB)/2) |
| 12 | 1 | BW_CORESET | 2 | BW_CORESET − |
| | | | | BW_SSB |
| 13 | 1 | BW_CORESET | 3 | 0 |
| 14 | 1 | BW_CORESET | 3 | floor((BW_CORESET − |
| | | | | BW_SSB)/2) |
| 15 | 1 | BW_CORESET | 3 | BW_CORESET − |
| | | | | BW_SSB |

TABLE 7
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHz (e.g., 3 MHz), and/or the channel bandwidth is 3 MHz.

| | SS/PBCH block and | | | |
|---|---|---|---|---|
| | CORESET multiplexing | Number of | Number of | |
| Index | pattern | RBs | Symbols | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 12 | 2 | 0 |
| 7 | 1 | 12 | 2 | −1 |
| 8 | 1 | 12 | 2 | −2 |
| 9 | 1 | 12 | 3 | 0 |
| 10 | 1 | 12 | 3 | −1 |
| 11 | 1 | 12 | 3 | −2 |
| 12 | | | | |
| 13 | | | | |
| 14 | | | | |
| 15 | | | | |

TABLE 8
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHz (e.g., 3 MHz), and/or the channel bandwidth is 3 MHz.

| | SS/PBCH block and | | | |
|---|---|---|---|---|
| | CORESET multiplexing | Number of | Number of | |
| Index | pattern | RBs | Symbols | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 12 | 1 | 0 |
| 7 | 1 | 12 | 1 | −1 |
| 8 | 1 | 12 | 1 | −2 |
| 9 | 1 | 12 | 2 | 0 |
| 10 | 1 | 12 | 2 | −1 |
| 11 | 1 | 12 | 2 | −2 |
| 12 | 1 | 12 | 3 | 0 |
| 13 | 1 | 12 | 3 | −1 |
| 14 | 1 | 12 | 3 | −2 |
| 15 | | | | |

TABLE 9
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHz (e.g., 3 MHz), and/or the channel bandwidth is 3 MHz.

| | SS/PBCH block and | | | |
|---|---|---|---|---|
| | CORESET multiplexing | Number of | Number of | |
| Index | pattern | RBs | Symbols | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 12 | 2 | 0 |
| 7 | 1 | 12 | 2 | −1 |
| 8 | 1 | 12 | 2 | −2 |
| 9 | 1 | 12 | 3 | 0 |
| 10 | 1 | 12 | 3 | −1 |
| 11 | 1 | 12 | 3 | −2 |
| 12 | 1 | 16 | 3 | 0 |
| 13 | 1 | 16 | 3 | 1 |
| 14 | 1 | 16 | 3 | 2 |
| 15 | | | | |

TABLE 10
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHz (e.g., 3 MHz), and/or the channel bandwidth is 3 MHz.

| | SS/PBCH block and | | | |
|---|---|---|---|---|
| | CORESET multiplexing | Number of | Number of | |
| Index | pattern | RBs | Symbols | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 16 | 3 | 0 |
| 7 | 1 | 16 | 3 | 1 |
| 8 | 1 | 16 | 3 | 2 |
| 9 | | | | |
| 10 | | | | |
| 11 | | | | |
| 12 | | | | |
| 13 | | | | |
| 14 | | | | |
| 15 | | | | |

TABLE 11
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHz (e.g., 3 MHz), and/or the channel bandwidth is 3 MHz.

| | SS/PBCH block and | | | |
|---|---|---|---|---|
| | CORESET multiplexing | Number of | Number of | |
| Index | pattern | RBs | Symbols | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 12 | 2 | 0 |
| 7 | 1 | 12 | 2 | −1 |
| 8 | 1 | 12 | 2 | −2 |
| 9 | 1 | 12 | 2 | −3 |
| 10 | 1 | 12 | 3 | 0 |
| 11 | 1 | 12 | 3 | −1 |
| 12 | 1 | 12 | 3 | −2 |
| 13 | 1 | 12 | 3 | −3 |
| 14 | | | | |
| 15 | | | | |

TABLE 12
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHz (e.g., 3 MHz), and/or the channel bandwidth is 3 MHz.

| | SS/PBCH block and | | | |
|---|---|---|---|---|
| | CORESET multiplexing | Number of | Number of | |
| Index | pattern | RBs | Symbols | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 12 | 2 | 0 |
| 7 | 1 | 12 | 2 | −2 |
| 8 | 1 | 12 | 2 | −4 |
| 9 | 1 | 12 | 3 | 0 |
| 10 | 1 | 12 | 3 | −2 |
| 11 | 1 | 12 | 3 | −4 |
| 12 | 1 | 16 | 3 | 0 |
| 13 | 1 | 16 | 3 | 1 |
| 14 | | | | |
| 15 | | | | |

TABLE 13
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHz (e.g., 3 MHz), and/or the channel bandwidth is 3 MHz.

| | SS/PBCH block and | | | |
|---|---|---|---|---|
| | CORESET multiplexing | Number of | Number of | |
| Index | pattern | RBs | Symbols | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 12 | 2 | 0 |
| 7 | 1 | 12 | 2 | −2 |
| 8 | 1 | 12 | 2 | −4 |
| 9 | 1 | 12 | 3 | 0 |
| 10 | 1 | 12 | 3 | −2 |
| 11 | 1 | 12 | 3 | −4 |
| 12 | 1 | 16 | 3 | 0 |
| 13 | | | | |
| 14 | | | | |
| 15 | | | | |

TABLE 14
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHz (e.g., 3 MHz), and/or the channel bandwidth is 3 MHz.

| | SS/PBCH block and | | | |
|---|---|---|---|---|
| | CORESET multiplexing | Number of | Number of | |
| Index | pattern | RBs | Symbols | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 12 | 2 | 0 |
| 7 | 1 | 12 | 2 | −1 |
| 8 | 1 | 12 | 2 | −2 |
| 9 | 1 | 12 | 2 | −3 |
| 10 | 1 | 12 | 2 | −4 |
| 11 | 1 | 16 | 3 | 0 |
| 12 | | | | |
| 13 | | | | |
| 14 | | | | |
| 15 | | | | |

TABLE 15
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHz (e.g., 3 MHz), and/or the channel bandwidth is 3 MHz.

| | SS/PBCH block and | | | |
|---|---|---|---|---|
| | CORESET multiplexing | Number of | Number of | |
| Index | pattern | RBs | Symbols | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 12 | 2 | 0 |
| 7 | 1 | 12 | 2 | −1 |
| 8 | 1 | 12 | 2 | −2 |
| 9 | 1 | 12 | 2 | −3 |
| 10 | 1 | 12 | 3 | 0 |
| 11 | 1 | 12 | 3 | −1 |
| 12 | 1 | 12 | 3 | −2 |
| 13 | 1 | 12 | 3 | −3 |
| 14 | 1 | 16 | 3 | 0 |
| 15 | 1 | 16 | 3 | 1 |

TABLE 16
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHz (e.g., 3 MHz), and/or the channel bandwidth is 3 MHz.

| | SS/PBCH block and | | | |
|---|---|---|---|---|
| | CORESET multiplexing | Number of | Number of | |
| Index | pattern | RBs | Symbols | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 12 | 2 | 0 |
| 7 | 1 | 12 | 3 | 0 |
| 8 | | | | |
| 9 | | | | |
| 10 | | | | |
| 11 | | | | |
| 12 | | | | |
| 13 | | | | |
| 14 | | | | |
| 15 | | | | |

TABLE 17
Example set of resource blocks and slot symbols of CORESET
for Type0-PDCCH search space set when {SS/PBCH block,
PDCCH} SCS is {15, 15} kHz for frequency bands
with minimum channel bandwidth smaller than 5 MHz (e.g., 3 MHz).

| | SS/PBCH block and | | | |
|---|---|---|---|---|
| | CORESET multiplexing | Number of | Number of | |
| Index | pattern | RBs | Symbols | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 12 | 2 | 0 |
| 7 | 1 | 12 | 3 | 0 |
| 8 | 1 | 16 | 3 | 0 |
| 9 | 1 | 16 | 3 | 1 |
| 10 | 1 | 16 | 3 | 2 |
| 11 | 1 | 16 | 3 | 3 |
| 12 | 1 | 16 | 3 | 4 |
| 13 | | | | |
| 14 | | | | |
| 15 | | | | |

TABLE 18
Example set of resource blocks and slot symbols of CORESET
for Type0-PDCCH search space set when {SS/PBCH block,
PDCCH} SCS is {15, 15} kHz for frequency bands
with minimum channel bandwidth smaller than 5 MHz (e.g., 3 MHz).

| | SS/PBCH block and | | | |
|---|---|---|---|---|
| | CORESET multiplexing | Number of | Number of | |
| Index | pattern | RBs | Symbols | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 12 | 2 | 0 |
| 7 | 1 | 12 | 3 | 0 |
| 8 | 1 | 16 | 3 | 0 |
| 9 | | | | |
| 10 | | | | |
| 11 | | | | |
| 12 | | | | |
| 13 | | | | |
| 14 | | | | |
| 15 | | | | |

TABLE 19
Example set of resource blocks and slot symbols of CORESET
for Type0-PDCCH search space set when {SS/PBCH block,
PDCCH} SCS is {15, 15} kHz for frequency bands
with minimum channel bandwidth smaller than 5 MHz (e.g., 3 MHz).

| | SS/PBCH block | | | |
|---|---|---|---|---|
| | and CORESET | | | |
| | multiplexing | Number of | Number of | Offset |
| Index | pattern | RBs | Symbols | (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 12 | 2 | 0 |
| 7 | 1 | 12 | 3 | 0 |
| 8 | 1 | 16 | 3 | 2 |
| 9 | | | | |
| 10 | | | | |
| 11 | | | | |
| 12 | | | | |
| 13 | | | | |
| 14 | | | | |
| 15 | | | | |

In another embodiment, the configuration table for CORESET #0, wherein the SS/PBCH block SCS and CORESET #0 SCS are both 15 kHz, can use the same configuration table as the legacy table (wherein the legacy table is for minimum channel bandwidth as 5 MHz or 10 MHz), when the minimum channel bandwidth is smaller than 5 MHz (e.g., 3 MHz). A UE can determine the SS/PBCH block and CORESET #0 multiplexing pattern, the number of RBs for CORESET #0 bandwidth, the number of symbols for CORESET #0, and the RB offset between SS/PBCH block and the CORESET #0, based on the indication of a configuration in the configuration table for CORESET #0. An example of a legacy table is shown in Table 20, and it can be also used for frequency bands with minimum channel bandwidth smaller than 5 MHz (e.g., 3 MHz). In one further consideration, when the frequency bands have a minimum channel bandwidth smaller than 5 MHz (e.g., 3 MHz), there can be a further condition that the channel bandwidth is larger than 3 MHz (e.g., at least 5 MHz). In another further consideration, when the frequency bands have a minimum channel bandwidth smaller than 5 MHz (e.g., 3 MHz), there can be a further condition that the channel bandwidth is larger than 5 MHz (e.g., at least 10 MHz).

TABLE 20
Example set of resource blocks and slot symbols of
CORESET for Type0-PDCCH search space set when {SS/PBCH
block, PDCCH} SCS is {15, 15} kHz for
frequency bands with minimum channel bandwidth as
3 MHz (e.g., and channel bandwidth is at least 5
MHz when minimum channel bandwidth is 3 MHz, or channel
bandwidth is larger than 5 MHz when minimum channel
bandwidth is 3 MHz), 5 MHz, or 10 MHz.

| | SS/PBCH block | | | |
|---|---|---|---|---|
| | and CORESET | | | |
| | multiplexing | Number of | Number of | Offset |
| Index | pattern | RBs | Symbols | (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | 48 | 3 | 12 |
| 11 | 1 | 48 | 3 | 16 |
| 12 | 1 | 96 | 1 | 38 |
| 13 | 1 | 96 | 2 | 38 |
| 14 | 1 | 96 | 3 | 38 |

| | |
|---|---|
| 15 | Reserved |

In one example, the UE determines the SS/PBCH block and CORESET #0 multiplexing pattern is the same as the indicated SS/PBCH block and CORESET #0 multiplexing pattern from the configuration table.

In another example, the UE determines the number of symbols for CORESET #0 is the same as the indicated number of symbols for CORESET #0 from the configuration table.

In yet another example, the UE determines the number of RBs for CORESET #0 bandwidth and/or the RB offset based on the indication from the configuration table.

For one sub-example, for frequency bands with minimum channel bandwidth smaller than 5 MHz (e.g., 3 MHz), the UE expects to be configured with a CORESET #0 configuration with index 0, 1, 2, 3, 4, or 5. For instance, the UE doesn't expect to be configured with a CORESET #0 configuration with a number of RBs as CORESET #0 bandwidth larger than 24.

For another sub-example, for frequency bands with a minimum channel bandwidth smaller than 5 MHz (e.g., 3 MHz), the UE does not expect to be configured with {CORESET #0 bandwidth (e.g., denoted as N_BW), CORESET #0 number of symbols (e.g., N_symb)} as {48, 1}.

For yet another sub-example, for frequency bands with a minimum channel bandwidth smaller than 5 MHz (e.g., 3 MHz), the UE does not expect to be configured with {CORESET #0 bandwidth (e.g., denoted as N_BW), CORESET #0 number of symbols (e.g., N_symb)} as {96, 1}.

For yet another sub-example, for frequency bands with a minimum channel bandwidth smaller than 5 MHz (e.g., 3 MHz), the UE does not expect to be configured with {CORESET #0 bandwidth (e.g., denoted as N_BW), CORESET #0 number of symbols (e.g., N_symb)} as {96, 2}.

For yet another sub-example, for frequency bands with a minimum channel bandwidth smaller than 5 MHz (e.g., 3 MHz), the UE does not expect to be configured with {CORESET #0 bandwidth (e.g., denoted as N_BW), CORESET #0 number of symbols (e.g., N_symb)} as {96, 3}.

For another sub-example, when the UE is configured with a CORESET #0 configuration with a number of RBs as CORESET #0 bandwidth (e.g., denoted as N_BW) and a RB offset (e.g., denoted as N_FO), the UE can determine a first CORESET #0 (e.g., denoted as hypothetical CORESET #0) such that the bandwidth of the first CORESET #0 is given by the indicated number of RBs for CORESET #0 (e.g., the hypothetical bandwidth), and the difference from the smallest RB index of the CORESET for Type0-PDCCH CSS set with a hypothetical bandwidth given by the indicated number of RBs for CORESET #0 (e.g., before truncation), to the smallest RB index of the common RB overlapping with the first RB of the corresponding SS/PBCH block with a hypothetical bandwidth given by 20 RBs (e.g., before truncation) is given by the indicated RB offset, wherein the SCS of the RB offset is defined with respect to the SCS of the CORESET for Type0-PDCCH CSS set. The UE then determines a second CORESET #0 (e.g., denoted as the actual CORESET #0 or CORESET #0 after truncation) based on the first CORESET #0 by performing truncation to the RBs. The UE monitors Type0-PDCCH CSS set according to the second CORESET #0 (e.g., actual CORESET #0), e.g., the initial BWP is the same as the RBs corresponding to the second CORESET #0, and/or the CCE determination is according to the bandwidth of the second CORESET #0.
In one instance, the UE truncates the first CORESET #0 (e.g., the hypothetical CORESET #0) by N1 number of RBs from the lowest RBs and truncates N2 number of RBs from the highest RBs, such that the number of RBs for the second CORESET #0 (e.g., actual CORESET #0) is given by N_BW−N1−N2, and the difference from the lowest RB of the first CORESET #0 (e.g., hypothetical CORESET #0) to the lowest RB of the second CORESET #0 (e.g., actual CORESET #0) is given by N1.
In another instance, N_BW−N1−N2 equals to the bandwidth of SS/PBCH block after truncation (e.g., 12 RBs), and the offset between the lowest RB of SS/PBCH block after truncation and the lowest RB of the second CORESET #0 (e.g., actual CORESET #0) is 0.
In yet another instance, this example is not applicable to the configurations with N_BW=24, and when the UE is configured with N_BW, the UE follows the legacy behavior without truncation to the CORESET #0.
In yet another instance, N_BW=24, and N1+N2=8, such that the bandwidth of actual CORESET #0 is 16 RBs.
In yet another instance, N_BW=24, and N1+N2=12, such that the bandwidth of actual CORESET #0 is 12 RBs.
In yet another instance, N_BW=48, and N1+N2=36, such that the bandwidth of actual CORESET #0 is 12 RBs.
In yet another instance, N_BW=96, and N1+N2=84, such that the bandwidth of actual CORESET #0 is 12 RBs.
In yet another instance, N_BW=48, and N1+N2=33, such that the bandwidth of actual CORESET #0 is 15 RBs.
In yet another instance, N_BW=96, and N1+N2=81, such that the bandwidth of actual CORESET #0 is 15 RBs.
In yet another instance, N1 can be determined based on N_FO.
   For one sub-instance, N1=5 if N_FO=4; and/or N1=4 if N_FO=2; and/or N1=3 if N_FO=0.
   For another sub-instance, N1=1 if N_FO=4; and/or N1=4 if N_FO=2; and/or N1=7 if N_FO=0.
   For yet another sub-instance, N1=6 if N_FO=4; and/or N1=4 if N_FO=2; and/or N1=2 if N_FO=0.
   For yet another sub-instance, N1=6 if N_FO=4; and/or N1=4 if N_FO=2; and/or N1=3 if N_FO=0.
   For yet another sub-instance, N1=6 if N_FO=4; and/or N1=5 if N_FO=2; and/or N1=3 if N_FO=0.
   For yet another sub-instance, N1=7 if N_FO=4; and/or N1=6 if N_FO=2; and/or N1=5 if N_FO=0.
   For yet another sub-instance, N1=7 if N_FO=4; and/or N1=5 if N_FO=2; and/or N1=3 if N_FO=0.
   For yet another sub-instance, N1=8 if N_FO=4; and/or N1=6 if N_FO=2; and/or N1=4 if N_FO=0.
   For yet another sub-instance, N1=6 if N_FO=4; and/or N1=6 if N_FO=2; and/or N1=6 if N_FO=0.
   For yet another sub-instance, N1=6 if N_FO=4; and/or N1=4 if N_FO=2; and/or N1=2 if N_FO=0.
   For yet another sub-instance, N1=16 if N_FO=12; and/or N1=20 if N_FO=16.
   For yet another sub-instance, N1=42 if N_FO=38.
   For yet another sub-instance, N1=16 if N_FO=12; and/or N1=17 if N_FO=16.
In yet another instance, N1 can be fixed, e.g., N1=6.

For yet another sub-example, when the UE is configured with a CORESET #0 configuration with a number of RBs as CORESET #0 bandwidth (e.g., denoted as N_BW) and a RB offset (e.g., denoted as N_FO), the UE can determine the location of the actual CORESET #0 based on a number of RBs as the actual CORESET #0 bandwidth and an offset (e.g., the actual offset between actual SS/PBCH block and actual CORESET #0) defined as the difference from the smallest RB index of the actual CORESET for Type0-PDCCH CSS set (e.g., after truncation), to the smallest RB index of the common RB overlapping with the first RB of the corresponding SS/PBCH block (e.g., after truncation), based on N_BW and N_FO. The UE monitors Type0-PDCCH CSS set according to the actual CORESET #0, e.g., the initial BWP is same as the RBs corresponding to the actual CORESET #0, and/or the CCE determination is according to the bandwidth of the actual CORESET #0.
In one instance, when N_BW is 24 RBs, the number of RBs of the actual CORESET #0 bandwidth can be 16.
In another instance, when N_BW is 24 RBs, the number of RBs of the actual CORESET #0 bandwidth can be 12.
In yet another instance, when N_BW is not 24 RBs, the number of RBs of the actual CORESET #0 bandwidth can be 12.
In yet another instance, when N_BW is not 24 RBs, the number of RBs of the actual CORESET #0 bandwidth can be 15.
In yet another instance, this example is not applicable to the configurations with N_BW=24, and when the UE is configured with N_BW, the UE follows the legacy behavior without truncation to the CORESET #0.
In yet another instance, the actual RB offset can be determined based on N_FO.
   For one sub-instance, the actual RB offset=N_FO/2, wherein N_FO can be 4, 2, or 0.
   For another sub-instance, the actual RB offset can be 2, when N_FO=4; and/or the actual RB offset can be 1, when N_FO=2; and/or the actual RB offset can be 0, when N_FO=0.
   For yet another sub-instance, the actual RB offset can be 0, when N_FO=4; and/or the actual RB offset can be 1, when N_FO=2; and/or the actual RB offset can be 2, when N_FO=0.
   For yet another sub-instance, the actual RB offset can be 0, when N_FO=4; and/or the actual RB offset can be −1, when N_FO=2; and/or the actual RB offset can be −2, when N_FO=0.
   For yet another sub-instance, the actual RB offset can be −2, when N_FO=4; and/or the actual RB offset can be −1, when N_FO=2; and/or the actual RB offset can be 0, when N_FO=0.
   For yet another sub-instance, the actual RB offset can be 0, when N_FO=4; and/or the actual RB offset can be 0, when N_FO=2; and/or the actual RB offset can be 0, when N_FO=0.
   For yet another sub-instance, the actual RB offset can be −1, when N_FO=4; and/or the actual RB offset can be −1, when N_FO=2; and/or the actual RB offset can be −1, when N_FO=0.
   For yet another sub-instance, the actual RB offset can be 0, when N_FO=12; and/or the actual RB offset can be 0, when N_FO=16.
   For yet another sub-instance, the actual RB offset can be 0, when N_FO=12; and/or the actual RB offset can be 3, when N_FO=16.
   For yet another sub-instance, the actual RB offset can be 0, when N_FO=38.
   For yet another sub-instance, the actual RB offset can be 1, when N_FO=38.
   For yet another sub-instance, the actual RB offset can be 2, when N_FO=38.
In yet another instance, the actual RB offset can be fixed, e.g., as 0 or −1.

In yet another embodiment, the configuration table for CORESET #0, wherein the SS/PBCH block SCS and CORESET #0 SCS are both 15 kHz, can be common for the minimum channel bandwidth smaller than 5 MHz (e.g., 3 MHz, or with a further condition that channel bandwidth is at least 5 MHz) or as 5 MHz or 10 MHz. An example of the table is shown in Table 21 to Table 24, wherein X is a fixed number in the Table 22 and Table 23 (e.g., X=0, or X=−1, or X=−2, or X=−3), or Y is a fixed number in the Table 21 (e.g., Y=0, or Y=1, or Y=2, or Y=3, or Y=4), or Z is a fixed number in the Table 24 (e.g., Z=2 or Z=3), or Z in the Table 24 is a number to be selected from 2 or 3 (e.g., up to the UE to decide 2 or 3). For Table 24, when the UE is configured with row 15, the UE truncates the CORESET #0 bandwidth from 24 RBs to 20 RBs, e.g., after CCE-to-REG mapping, wherein for instance, the CORESET #0 bandwidth after truncation is aligned with the SS/PBCH block bandwidth (e.g., both as 20 RBs). In one instance for Table 24, interleaving for CCE-to-REG mapping is not applied.

TABLE 21
Example set of resource blocks and slot symbols of CORESET
for Type0-PDCCH search space set when {SS/PBCH block,
PDCCH} SCS is {15, 15} kHz for frequency
bands with minimum channel bandwidth as 3 MHz (e.g.,
and channel bandwidth is at least 5 MHz when minimum
channel bandwidth is 3 MHz), 5 MHz, or 10 MHz.

| | SS/PBCH block | | | |
|---|---|---|---|---|
| | and CORESET | | | |
| | multiplexing | Number of | Number of | Offset |
| Index | pattern | RBs | Symbols | (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | 48 | 3 | 12 |
| 11 | 1 | 48 | 3 | 16 |
| 12 | 1 | 96 | 1 | 38 |
| 13 | 1 | 96 | 2 | 38 |
| 14 | 1 | 96 | 3 | 38 |
| 15 | 1 | 16 | 3 | Y |

TABLE 22
Example set of resource blocks and slot symbols of CORESET
for Type0-PDCCH search space set when {SS/PBCH block,
PDCCH} SCS is {15, 15} kHz for frequency
bands with minimum channel bandwidth as 3 MHZ (e.g.,
and channel bandwidth is at least 5 MHz when minimum
channel bandwidth is 3 MHz), 5 MHz, or 10 MHz.

| | SS/PBCH block | | | |
|---|---|---|---|---|
| | and CORESET | | | |
| | multiplexing | Number of | Number of | Offset |
| Index | pattern | RBs | Symbols | (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | 48 | 3 | 12 |
| 11 | 1 | 48 | 3 | 16 |
| 12 | 1 | 96 | 1 | 38 |
| 13 | 1 | 96 | 2 | 38 |
| 14 | 1 | 96 | 3 | 38 |
| 15 | 1 | 12 | 2 | X |

TABLE 23
Example set of resource blocks and slot symbols of CORESET
for Type0-PDCCH search space set when {SS/PBCH block,
PDCCH} SCS is {15, 15} kHz for frequency
bands with minimum channel bandwidth as 3 MHz (e.g.,
and channel bandwidth is at least 5 MHz when minimum
channel bandwidth is 3 MHz), 5 MHz, or 10 MHz.

| | SS/PBCH block | | | |
|---|---|---|---|---|
| | and CORESET | | | |
| | multiplexing | Number of | Number of | Offset |
| Index | pattern | RBs | Symbols | (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | 48 | 3 | 12 |
| 11 | 1 | 48 | 3 | 16 |
| 12 | 1 | 96 | 1 | 38 |
| 13 | 1 | 96 | 2 | 38 |
| 14 | 1 | 96 | 3 | 38 |
| 15 | 1 | 12 | 3 | X |

TABLE 24
Example set of resource blocks and slot symbols of CORESET
for Type0-PDCCH search space set when {SS/PBCH block,
PDCCH} SCS is {15, 15} kHz for frequency
bands with minimum channel bandwidth as 3 MHz (e.g.,
and channel bandwidth is at least 5 MHz when minimum
channel bandwidth is 3 MHz), 5 MHz, or 10 MHz.

| | SS/PBCH block | | | |
|---|---|---|---|---|
| | and CORESET | | | |
| | multiplexing | Number of | Number of | Offset |
| Index | pattern | RBs | Symbols | (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | 48 | 3 | 12 |
| 11 | 1 | 48 | 3 | 16 |
| 12 | 1 | 96 | 1 | 38 |
| 13 | 1 | 96 | 2 | 38 |
| 14 | 1 | 96 | 3 | 38 |
| 15 | 1 | 24 | Z | 0 |

In one embodiment, a combination of the above components can be supported, e.g. using a new table indicated using 4 bits (e.g., searchSpaceZero) in a MIB, and performing truncation to the CORESET #0 according to examples in this disclosure.

In one example, the example table is shown in Table 25, and for configurations with index 4 to 5 (or 2 to 3), the interleaving for CCE-to-REG mapping is not applied. The offset in the table refers to the one from the smallest RB index of the CORESET for Type0-PDCCH CSS set to the smallest RB index of the common RB overlapping with the first RB of the corresponding SS/PBCH block with truncated bandwidth, e.g., truncated from 20 RBs to 12 RBs. For configurations with index 2 to 5, the CORESET #0 bandwidth can be truncated to 15 RBs after the CCE-to-REG mapping, e.g., by truncating the highest 9 RBs from the CORESET #0 bandwidth.

TABLE 25
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHz (e.g., 3 MHz), and/or the channel bandwidth is 3 MHz.

| | SS/PBCH block | | | |
|---|---|---|---|---|
| | and CORESET | | | |
| | multiplexing | Number of | Number of | Offset |
| Index | pattern | RBs | Symbols | (RBs) |
| 0 | 1 | 12 | 2 | 0 |
| 1 | 1 | 12 | 3 | 0 |
| 2 | 1 | 24 | 2 | 0 |
| 3 | 1 | 24 | 3 | 0 |
| 4 | 1 | 24 | 2 | 0 |
| 5 | 1 | 24 | 3 | 0 |
| 6 | | | | |
| 7 | | | | |
| 8 | | | | |
| 9 | | | | |
| 10 | | | | |
| 11 | | | | |
| 12 | | | | |
| 13 | | | | |
| 14 | | | | |
| 15 | | | | |

In another example, the example table is shown in Table 26, and for configurations with index 6 to 9 (or 2 to 5), the interleaving for CCE-to-REG mapping is not applied. The offset in the table refers to the one from the smallest RB index of the CORESET for Type0-PDCCH CSS set to the smallest RB index of the common RB overlapping with the first RB of the corresponding SS/PBCH block with truncated bandwidth, e.g., truncated from 20 RBs to 12 RBs. For configurations with index 2 to 9, the CORESET #0 bandwidth can be truncated to 15 RBs after the CCE-to-REG mapping, e.g., by truncating the highest 9 RBs from the CORESET #0 bandwidth. In this example, A is a fixed integer, such as A=3, or A=2, or A=1.

TABLE 26
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHZ (e.g., 3 MHz), and/or the channel bandwidth is 3 MHz.

| | SS/PBCH block | | | |
|---|---|---|---|---|
| | and CORESET | | | |
| | multiplexing | Number of | Number of | Offset |
| Index | pattern | RBs | Symbols | (RBs) |
| 0 | 1 | 12 | 2 | 0 |
| 1 | 1 | 12 | 3 | 0 |
| 2 | 1 | 24 | 2 | 0 |
| 3 | 1 | 24 | 2 | A |
| 4 | 1 | 24 | 3 | 0 |
| 5 | 1 | 24 | 3 | A |
| 6 | 1 | 24 | 2 | 0 |
| 7 | 1 | 24 | 2 | A |
| 8 | 1 | 24 | 3 | 0 |
| 9 | 1 | 24 | 3 | A |
| 10 | | | | |
| 11 | | | | |
| 12 | | | | |
| 13 | | | | |
| 14 | | | | |

15

In yet another example, the example table is shown in Table 27, and 16 rows are selected from the table. For configurations with index 10 to 17 (or 2 to 9), the interleaving for CCE-to-REG mapping is not applied. The offset in the table refers to the one from the smallest RB index of the CORESET for Type0-PDCCH CSS set to the smallest RB index of the common RB overlapping with the first RB of the corresponding SS/PBCH block with truncated bandwidth, e.g., truncated from 20 RBs to 12 RBs. For configurations with index 2 to 17, the CORESET #0 bandwidth can be truncated to 15 RBs after the CCE-to-REG mapping, e.g., by truncating the highest 9 RBs from the CORESET #0 bandwidth.

TABLE 27
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHz (e.g., 3 MHz), and/or the channel bandwidth is 3 MHz.

| | SS/PBCH block | | | |
|---|---|---|---|---|
| | and CORESET | | | |
| | multiplexing | Number of | Number of | Offset |
| Index | pattern | RBs | Symbols | (RBs) |
| 0 | 1 | 12 | 2 | 0 |
| 1 | 1 | 12 | 3 | 0 |
| 2 | 1 | 24 | 2 | 0 |
| 3 | 1 | 24 | 2 | 1 |
| 4 | 1 | 24 | 2 | 2 |
| 5 | 1 | 24 | 2 | 3 |
| 6 | 1 | 24 | 3 | 0 |
| 7 | 1 | 24 | 3 | 1 |
| 8 | 1 | 24 | 3 | 2 |
| 9 | 1 | 24 | 3 | 3 |
| 10 | 1 | 24 | 2 | 0 |
| 11 | 1 | 24 | 2 | 1 |
| 12 | 1 | 24 | 2 | 2 |
| 13 | 1 | 24 | 2 | 3 |
| 14 | 1 | 24 | 3 | 0 |
| 15 | 1 | 24 | 3 | 1 |
| 16 | 1 | 24 | 3 | 2 |
| 17 | 1 | 24 | 3 | 3 |

In yet another example, the example table is shown in Table 28, and for configurations with index 4 to 5 (or 2 to 3), the interleaving for CCE-to-REG mapping is not applied. The offset in the table refers to the one from the smallest RB index of the CORESET for Type0-PDCCH CSS set to the smallest RB index of the common RB overlapping with the first RB of the corresponding SS/PBCH block before truncating bandwidth, e.g., 20 RBs. For configurations with index 2 to 5, the CORESET #0 bandwidth can be truncated to 15 RBs after the CCE-to-REG mapping, e.g., by truncating the highest 5 RBs and lowest 4 RBs from the CORESET #0 bandwidth.

TABLE 28
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHz (e.g., 3 MHz), and/or the channel bandwidth is 3 MHz.

| | SS/PBCH block | | | |
|---|---|---|---|---|
| | and CORESET | | | |
| | multiplexing | Number of | Number of | Offset |
| Index | pattern | RBs | Symbols | (RBs) |
| 0 | 1 | 12 | 2 | −4 |
| 1 | 1 | 12 | 3 | −4 |
| 2 | 1 | 24 | 2 | 0 |
| 3 | 1 | 24 | 3 | 0 |
| 4 | 1 | 24 | 2 | 0 |
| 5 | 1 | 24 | 3 | 0 |
| 6 | | | | |
| 7 | | | | |
| 8 | | | | |
| 9 | | | | |
| 10 | | | | |
| 11 | | | | |
| 12 | | | | |
| 13 | | | | |
| 14 | | | | |
| 15 | | | | |

In yet another example, the example table is shown in Table 29. For configurations with index 6 to 7 (or 8 to 9), the interleaving for CCE-to-REG mapping is not applied. For configurations with index 6 to 9, the CORESET #0 bandwidth can be truncated to 20 RBs after the CCE-to-REG mapping, e.g., by truncating the highest 4 RBs from the CORESET #0 bandwidth (such that the CORESET #0 bandwidth and SS/PBCH block bandwidth are the same).

TABLE 29
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHz (e.g., 3 MHZ), and/or the channel bandwidth is 5 MHz.

| | SS/PBCH block | | | |
|---|---|---|---|---|
| | and CORESET | | | |
| | multiplexing | Number of | Number of | Offset |
| Index | pattern | RBs | Symbols | (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 24 | 2 | 0 |
| 7 | 1 | 24 | 3 | 0 |
| 8 | 1 | 24 | 2 | 0 |
| 9 | 1 | 24 | 3 | 0 |
| 10 | | | | |
| 11 | | | | |
| 12 | | | | |
| 13 | | | | |
| 14 | | | | |
| 15 | | | | |

In yet another example, the example table is shown in Table 30. For one instance, for configurations with index 6 to 7, the interleaving for CCE-to-REG mapping is not applied. For configurations with index 6 to 7, the CORESET #0 bandwidth can be truncated to 20 RBs after the CCE-to-REG mapping, e.g., by truncating the highest 4 RBs from the CORESET #0 bandwidth (such that the CORESET #0 bandwidth and SS/PBCH block bandwidth are the same).

TABLE 30
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5
MHz (e.g., 3 MHz), and/or the channel bandwidth is 5 MHz.

| | SS/PBCH block | | | |
|---|---|---|---|---|
| | and CORESET | | | |
| | multiplexing | Number of | Number of | Offset |
| Index | pattern | RBs | Symbols | (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 24 | 2 | 0 |
| 7 | 1 | 24 | 3 | 0 |
| 8 | | | | |
| 9 | | | | |
| 10 | | | | |
| 11 | | | | |
| 12 | | | | |
| 13 | | | | |
| 14 | | | | |
| 15 | | | | |

In yet another example, the example table is shown in Table 31. For one instance, for configurations with index 6 to 9 (or 2 to 5), the interleaving for CCE-to-REG mapping is not applied. For another instance, for configurations with index 14 to 15, the interleaving for CCE-to-REG mapping is not applied. The offset in the table refers to the one from the smallest RB index of the CORESET for Type0-PDCCH CSS set to the smallest RB index of the common RB overlapping with the first RB of the corresponding SS/PBCH block with truncated bandwidth when applicable, e.g., truncated from 20 RBs to 12 RBs. For configurations with index 2 to 9, the CORESET #0 bandwidth can be truncated to 15 RBs after the CCE-to-REG mapping, e.g., by truncating the highest 9 RBs from the CORESET #0 bandwidth. For configurations with index 14 to 15, the CORESET #0 bandwidth can be truncated to 20 RBs after the CCE-to-REG mapping, e.g., by truncating the highest 4 RBs from the CORESET #0 bandwidth. In this example, A is a fixed integer, such as A=3, or A=2, or A=1. In this example, B is a fixed integer, such as B=2, or B=3, or B=4.

TABLE 31
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5 MHZ
(e.g., 3 MHz), and/or the channel bandwidth is 3 MHz or 5 MHz.

| | SS/PBCH block | | | |
|---|---|---|---|---|
| | and CORESET | | | |
| | multiplexing | Number of | Number of | Offset |
| Index | pattern | RBs | Symbols | (RBs) |
| 0 | 1 | 12 | 2 | 0 |
| 1 | 1 | 12 | 3 | 0 |
| 2 | 1 | 24 | 2 | 0 |
| 3 | 1 | 24 | 2 | A |
| 4 | 1 | 24 | 3 | 0 |
| 5 | 1 | 24 | 3 | A |
| 6 | 1 | 24 | 2 | 0 |
| 7 | 1 | 24 | 2 | A |
| 8 | 1 | 24 | 3 | 0 |
| 9 | 1 | 24 | 3 | A |
| 10 | 1 | 24 | 2 | 0 |
| 11 | 1 | 24 | 2 | B |
| 12 | 1 | 24 | 3 | 0 |
| 13 | 1 | 24 | 3 | B |
| 14 | 1 | 24 | 2 | 0 |
| 15 | 1 | 24 | 3 | 0 |

In yet another example, the example table is shown in Table: 32. For one instance, for configurations with index 6 to 9 (or 2 to 5), the interleaving for CCE-to-REG mapping is not applied (e.g., non-interleaving CCE-to-REG mapping is applied). For another instance, for configurations with index 10 to 11, the interleaving for CCE-to-REG mapping is not applied (e.g., non-interleaving CCE-to-REG mapping is applied). The offset in the table refers to the one from the smallest RB index of the CORESET for Type0-PDCCH CSS set to the smallest RB index of the common RB overlapping with the first RB of the corresponding SS/PBCH block with truncated bandwidth when applicable, e.g., when the SS/PBCH block bandwidth is truncated from 20 RBs to 12 RBs. For configurations with index 2 to 9, the CORESET #0 bandwidth can be truncated to 15 RBs after applying the CCE-to-REG mapping, e.g., by truncating the highest 9 RBs from the CORESET #0 bandwidth. For configurations with index 10 to 11, the CORESET #0 bandwidth can be truncated to 20 RBs after applying the CCE-to-REG mapping, e.g., by truncating the highest 4 RBs from the CORESET #0 bandwidth. In this example, A is a fixed integer, such as A=3, or A=2, or A=1.

TABLE 32
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5 MHZ
(e.g., 3 MHz), and/or the channel bandwidth is 3 MHz or 5 MHz.

| | SS/PBCH block | | | |
|---|---|---|---|---|
| | and CORESET | | | |
| | multiplexing | Number of | Number of | Offset |
| Index | pattern | RBs | Symbols | (RBs) |
| 0 | 1 | 12 | 2 | 0 |
| 1 | 1 | 12 | 3 | 0 |
| 2 | 1 | 24 | 2 | 0 |
| 3 | 1 | 24 | 2 | A |
| 4 | 1 | 24 | 3 | 0 |
| 5 | 1 | 24 | 3 | A |
| 6 | 1 | 24 | 2 | 0 |
| 7 | 1 | 24 | 2 | A |
| 8 | 1 | 24 | 3 | 0 |
| 9 | 1 | 24 | 3 | A |
| 10 | 1 | 24 | 2 | 0 |
| 11 | 1 | 24 | 3 | 0 |
| 12 | | | | |
| 13 | | | | |
| 14 | | | | |
| 15 | | | | |

In yet another example, the example table is shown in Table 33. For one instance, for configurations with index 6 to 9 (or 2 to 5), the interleaving for CCE-to-REG mapping is not applied. For another instance, for configurations with index 10 to 11 (or 12 to 13), the interleaving for CCE-to-REG mapping is not applied. The offset in the table refers to the one from the smallest RB index of the CORESET for Type0-PDCCH CSS set to the smallest RB index of the common RB overlapping with the first RB of the corresponding SS/PBCH block with truncated bandwidth when applicable, e.g., truncated from 20 RBs to 12 RBs. For configurations with index 2 to 9, the CORESET #0 bandwidth can be truncated to 15 RBs after the CCE-to-REG mapping, e.g., by truncating the highest 9 RBs from the CORESET #0 bandwidth. For configurations with index 10 to 13, the CORESET #0 bandwidth can be truncated to 20 RBs after the CCE-to-REG mapping, e.g., by truncating the highest 4 RBs from the CORESET #0 bandwidth. In this example, A is a fixed integer, such as A=3, or A=2, or A=1.

TABLE 33
Example set of resource blocks and slot symbols of CORESET
for Type0-PDCCH search space set when {SS/PBCH block,
PDCCH} SCS is {15, 15} kHz for frequency
bands with minimum channel bandwidth smaller than 5 MHz
(e.g., 3 MHz), and/or the channel bandwidth is 3 MHz or 5MHz.

| | SS/PBCH block and | | | |
|---|---|---|---|---|
| | CORESET multiplexing | Number of | Number of | Offset |
| Index | pattern | RBs | Symbols | (RBs) |
| 0 | 1 | 12 | 2 | 0 |
| 1 | 1 | 12 | 3 | 0 |
| 2 | 1 | 24 | 2 | 0 |
| 3 | 1 | 24 | 2 | A |
| 4 | 1 | 24 | 3 | 0 |
| 5 | 1 | 24 | 3 | A |
| 6 | 1 | 24 | 2 | 0 |
| 7 | 1 | 24 | 2 | A |
| 8 | 1 | 24 | 3 | 0 |
| 9 | 1 | 24 | 3 | A |
| 10 | 1 | 24 | 2 | 0 |
| 11 | 1 | 24 | 3 | 0 |
| 12 | 1 | 24 | 2 | 0 |
| 13 | 1 | 24 | 3 | 0 |
| 14 | | | | |
| 15 | | | | |

In one consideration for examples in this embodiment, the offset in the table refers to the one from the smallest RB index of the CORESET for Type0-PDCCH CSS set to the smallest RB index of the common RB overlapping with the first RB of the corresponding SS/PBCH block before truncating its bandwidth when applicable, and the corresponding offset value O will be replaced by O-4.

In one embodiment, there can be an indication on at least one of the following instances:
In a first instance, the frequency band is with a minimum channel bandwidth of 5 MHz or 10 MHz, or the frequency band is with a minimum channel bandwidth smaller than 5 MHz (e.g., 3 MHz).
In a second instance, the SS/PBCH block structure is with a number of RBs as 20 RBs (e.g., legacy SS/PBCH block) or with a number of RBs smaller than 20 MHz (e.g., truncated SS/PBCH block).
In a third instance, the configuration table for CORESET #0 is the legacy configuration table (e.g., as in Table 18) or a new configuration table (e.g., an example according to this disclosure).
In a forth instance, whether the UE shall perform truncation or not to the CORESET #0 bandwidth when using the legacy CORESET #0 configuration table (e.g., as in Table 20).

In one example, the indication is an implicit indication by synchronization raster entries. For instance, the frequency band with minimum channel bandwidth or transmission bandwidth smaller than 5 MHz (e.g., 3 MHz) can use a first set of synchronization raster entries, and the frequency band with minimum channel bandwidth or transmission bandwidth no smaller than 5 MHz (e.g. 5 MHz or 10 MHz) can use a second set of synchronization raster entries, wherein the first set and second set do not overlap. Then when a UE detects a SS/PBCH block corresponding to the first set of synchronization raster entries, the UE can assume the associated frequency band is with minimum channel bandwidth smaller than 5 MHz (e.g., 3 MHz), and/or assume the SS/PBCH block structure is a truncated one (e.g., bandwidth smaller than 20 RBs), and/or can use the new CORESET #0 configuration table, and/or can apply truncation to the CORESET #0 if using the legacy CORESET #0 configuration table; when the UE detects a SS/PBCH block corresponding to the second set of synchronization raster entries, the UE can assume the associated frequency band is with minimum channel bandwidth of 5 MHz or 10 MHz, and/or assume the SS/PBCH block structure is the legacy one (e.g., bandwidth as 20 RBs), and/or can use the legacy CORESET #0 configuration table, and/or may not apply truncation to the CORESET #0 if using the legacy CORESET #0 configuration table.

In one further consideration for this example, the UE does not expect a truncated SS/PBCH block (e.g., SS/PBCH block with bandwidth smaller than 20 RBs) corresponding to a cell (e.g. a SCell and/or a PSCell) is configured to be allocated on the frequency corresponding to a value in the first set of synchronization raster entries.

In another further consideration for this example, the UE does not expect a legacy SS/PBCH block (e.g., SS/PBCH block with bandwidth of 20 RBs) corresponding to a cell (e.g. a SCell and/or a PSCell) is configured to be allocated on the frequency corresponding to a value in the second set of synchronization raster entries.

In another example, the indication can be an explicit one in a PBCH payload. For one instance, when the indication takes a first value, the UE can assume the associated frequency band is with minimum channel bandwidth smaller than 5 MHz (e.g., 3 MHz), and/or assume the SS/PBCH block structure is a truncated one (e.g., bandwidth smaller than 20 RBs), and/or can use the CORESET #0 table associated with minimum channel bandwidth smaller than 5 MHz, and/or can apply truncation to the CORESET #0 if using the legacy CORESET #0 configuration table; when the indication takes a second value, the UE can assume the associated frequency band is with minimum channel bandwidth of 5 MHz or 10 MHz, and/or assume the SS/PBCH block structure is the legacy one (e.g., bandwidth as 20 RBs), and/or can use the CORESET #0 table associated with minimum channel bandwidth of 5 MHz or 10 MHz, and/or may not apply truncation to the CORESET #0 if using the legacy CORESET #0 configuration table.
In one instance, the indication can be using subCarrierSpacingCommon. For one sub-instance, the first value can be scs15or60, and the second value can be scs30or120. For another sub-instance, the first value can be scs30or120, and the second value can be scs15or60.
In another instance, the indication can be using spare. For one sub-instance, the first value can be 0, and the second value can be 1. For another sub-instance, the first value can be 1, and the second value can be 0.
In yet another instance, the indication can be using ā_{Ā+5}. For one sub-instance, the first value can be 0, and the second value can be 1. For another sub-instance, the first value can be 1, and the second value can be 0.
In yet another instance, the indication can be using ā_{Ā+6}. For one sub-instance, the first value can be 0, and the second value can be 1. For another sub-instance, the first value can be 1, and the second value can be 0.
In yet another instance, the indication can be using ā_{Ā+7}. For one sub-instance, the first value can be 0, and the second value can be 1. For another sub-instance, the first value can be 1, and the second value can be 0.

In yet another example, the indication can use the PSS sequence of the SS/PBCH block. For instance, a first set of PSS sequences can be used for the frequency band with minimum channel bandwidth smaller than 5 MHz (e.g., 3 MHz) and a second set of PSS sequences can be used for the frequency band with minimum channel bandwidth of 5 MHz or 10 MHz. For instance, the first set and second set of PSS sequences can be orthogonal or low cross correlation. Then when a UE detects the PSS sequence in the first set, the UE can assume the associated frequency band is with minimum channel bandwidth smaller than 5 MHz (e.g., 3 MHz), and/or assume the SS/PBCH block structure is a truncated one (e.g., bandwidth smaller than 20 RBs), and/or can use the CORESET #0 table associated with minimum channel bandwidth smaller than 5 MHz, and/or can apply truncation to the CORESET #0 if using the legacy CORESET #0 configuration table; when the UE detects the PSS sequence in the second set, the UE can assume the associated frequency band is with minimum channel bandwidth of 5 MHz or 10 MHz, and/or assume the SS/PBCH block structure is the legacy one (e.g., bandwidth as 20 RBs), and/or can use the CORESET #0 table associated with minimum channel bandwidth of 5 MHz or 10 MHz, and/or may not apply truncation to the CORESET #0 if using the legacy CORESET #0 configuration table.
In one instance, the PSS sequence of the SS/PBCH block used for band with minimum channel bandwidth smaller than 5 MHz can be generated based on d_PSS(n)=1−2*x(m), m=(n+43*N_ID\hat{ }(2)) mod 127, 0≤n<127, where x(i+7)=(x(i+1)+x(i)) mode 2, and [x(6) x(5) x(4) x(3) x(2) x(1) x(0)]=[1 1 1 0 1 1 0].
In another instance, the PSS sequence of the SS/PBCH block used for band with minimum channel bandwidth smaller than 5 MHz can be generated based on d_PSS(n)=1−2*x(m), m=(n+43*N_ID\hat{ }(2)) mod 127, 0<n<127, where x(i+7)=(x(i+3)+x(i)) mode 2, and [x(6) x(5) x(4) x(3) x(2) x(1) x(0)]=[1 1 1 0 1 1 0].
In yet another instance, the PSS sequence of the SS/PBCH block used for band with minimum channel bandwidth smaller than 5 MHz can be generated based on d_PSS(n)=1−2*x(m), m=(n+43*N_ID\hat{ }(2)) mod 127, 0≤n<127, where x(i+7)=(x(i+6)+x(i)) mode 2, and [x(6) x(5) x(4) x(3) x(2) x(1) x(0)]=[1 1 1 0 1 1 0].
In yet another instance, the PSS sequence of the SS/PBCH block used for band with minimum channel bandwidth smaller than 5 MHz can be generated based on d_PSS(n)=1−2*x(m), m=(n+43*N_ID\hat{ }(2)+k) mod 127, 0≤n<127, where x(i+7)=(x(i+4)+x(i)) mode 2, and [x(6) x(5) x(4) x(3) x(2) x(1) x(0)]=[1 1 1 0 1 1 0].
   k is an integer, e.g., k=10 or k=11.

In yet another example, the indication can use the DMRS sequence of PBCH in the SS/PBCH block. For instance, a first set of DMRS sequences are used for the frequency band with minimum channel bandwidth smaller than 5 MHz (e.g., 3 MHz), and a second set of DMRS sequences are used for the frequency band with minimum channel bandwidth of 5 MHz or 10 MHz. Then when a UE detects the DMRS sequence in the first set, the UE can assume the associated frequency band is with minimum channel bandwidth smaller than 5 MHz (e.g., 3 MHz), and/or assume the SS/PBCH block structure is a truncated one (e.g., bandwidth smaller than 20 RBs), and/or can use the CORESET #0 table associated with minimum channel bandwidth smaller than 5 MHz, and/or can apply truncation to the CORESET #0 if using the legacy CORESET #0 configuration table; when the UE detects the DMRS sequence in the second set, the UE can assume the associated frequency band is with minimum channel bandwidth of 5 MHz or 10 MHz, and/or assume the SS/PBCH block structure is the legacy one (e.g., bandwidth as 20 RBs), and/or can use the CORESET #0 table associated with minimum channel bandwidth of 5 MHz or 10 MHz, and/or may not apply truncation to the CORESET #0 if using the legacy CORESET #0 configuration table.

In yet another example, the indication can use the rate matching pattern of PBCH in the SS/PBCH block. For instance, a first rate matching pattern of PBCH can be used for the frequency band with minimum channel bandwidth smaller than 5 MHz (e.g., 3 MHz), and a second rate matching pattern of PBCH can be used for the frequency band with minimum channel bandwidth of 5 MHz or 10 MHz. Then when a UE detects the DMRS sequence in the first set, the UE can assume the associated frequency band is with minimum channel bandwidth smaller than 5 MHz (e.g., 3 MHz), and/or assume the SS/PBCH block structure is a truncated one (e.g., bandwidth smaller than 20 RBs), and/or can use the CORESET #0 table associated with minimum channel bandwidth smaller than 5 MHz, and/or can apply truncation to the CORESET #0 if using the legacy CORESET #0 configuration table; when the UE detects the DMRS sequence in the second set, the UE can assume the associated frequency band is with minimum channel bandwidth of 5 MHz or 10 MHz, and/or assume the SS/PBCH block structure is the legacy one (e.g., bandwidth as 20 RBs), and/or can use the CORESET #0 table associated with minimum channel bandwidth of 5 MHz or 10 MHz, and/or may not apply truncation to the CORESET #0 if using the legacy CORESET #0 configuration table.

In yet another example, the indication can use the SSS sequence of the SS/PBCH block. For instance, a first set of SSS sequences can be used for the frequency band with minimum channel bandwidth smaller than 5 MHz (e.g., 3 MHz) and a second set of SSS sequences can be used for the frequency band with minimum channel bandwidth of 5 MHz or 10 MHz. For instance, the first set and second set of SSS sequences can be orthogonal or low cross correlation. Then when a UE detects the SSS sequence in the first set, the UE can assume the associated frequency band is with minimum channel bandwidth smaller than 5 MHz (e.g., 3 MHz), and/or assume the SS/PBCH block structure is a truncated one (e.g., bandwidth smaller than 20 RBs), and/or can use the CORESET #0 table associated with minimum channel bandwidth smaller than 5 MHz, and/or can apply truncation to the CORESET #0 if using the legacy CORESET #0 configuration table; when the UE detects the SSS sequence in the second set, the UE can assume the associated frequency band is with minimum channel bandwidth of 5 MHz or 10 MHz, and/or assume the SS/PBCH block structure is the legacy one (e.g., bandwidth as 20 RBs), and/or can use the CORESET #0 table associated with minimum channel bandwidth of 5 MHz or 10 MHz, and/or may not apply truncation to the CORESET #0 if using the legacy CORESET #0 configuration table.

As previously discussed herein, the present disclosure includes the design of a CCE in CORESET #0, in a carrier with channel bandwidth narrower than 5 MHz.

In one embodiment, the CORESET bandwidth can be truncated from N_BW RBs to a smaller number, e.g., for frequency band with minimum channel bandwidth smaller than 5 MHz (e.g., 3 MHz) or for a channel with channel bandwidth smaller than 5 MHz (e.g., 3 MHz).

In one example, the CORESET can be CORESET #0, wherein N_BW is the number of RBs provided by the configuration in MIB, and N1 RBs are truncated from the lowest and/or N2 RBs are truncated form the highest, such that the remaining number of RBs for CORESET #0 is N_BW−N1−N2, wherein N1 and N2 are non-negative integers.

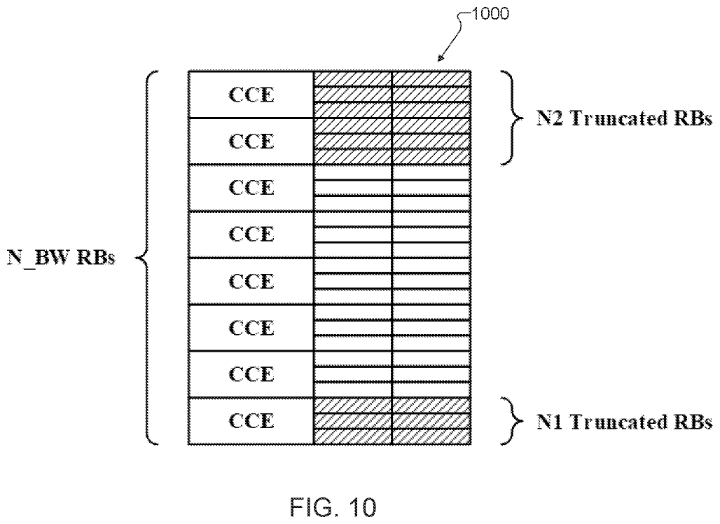

In one instance, the truncated RBs correspond to a number of CCEs (or REG bundles). N1 and/or N2 are integer multiple of L_REG/N_symb, wherein L_REG is the number of REGs in a REG bundle (e.g., L_REG can be fixed as 6), and N_symb is the number of symbols for CORESET #0. An illustration of this instance is shown in FIG. 10.
For one sub-instance, N1 and/or N2 are integer multiple of 2, when the number of symbols for CORESET #0 is 3.
For another sub-instance, N1 and/or N2 are integer multiple of 3, when the number of symbols for CORESET #0 is 2.
For yet another sub-instance, N1 and/or N2 are integer multiple of 6, when the number of symbols for CORESET #0 is 1.

FIG. 10 illustrates an example 1000 of truncation of CORESET #0 bandwidth according to embodiments of the present disclosure. The embodiment of truncation of CORESET #0 bandwidth of FIG. 10 is for illustration only. Different embodiments of truncation of CORESET #0 bandwidth could be used without departing from the scope of this disclosure.

In another instance, the number of RBs after truncation correspond to a number of CCEs (or REG bundles). N1+N2 are integer multiple of L_REG/N_symb, wherein L_REG is the number of REGs in a REG bundle (e.g., L_REG can be fixed as 6), and N_symb is the number of symbols for CORESET #0.

Although FIG. 10 illustrates an example 1000 of truncation of CORESET #0 bandwidth, various changes may be made to FIG. 10. For example, various changes to the CCEs, the RBs, the truncated RBs, etc. could be made according to particular needs.

In one embodiment, the interleaving function for CCE-to-REG mapping can be enhanced, e.g., for frequency band with minimum channel bandwidth smaller than 5 MHz (e.g., 3 MHz) or for a channel with channel bandwidth smaller than 5 MHz (e.g., 3 MHz). For one instance, the enhancement to the interleaving function for CCE-to-REG mapping can be for CORESET #0.

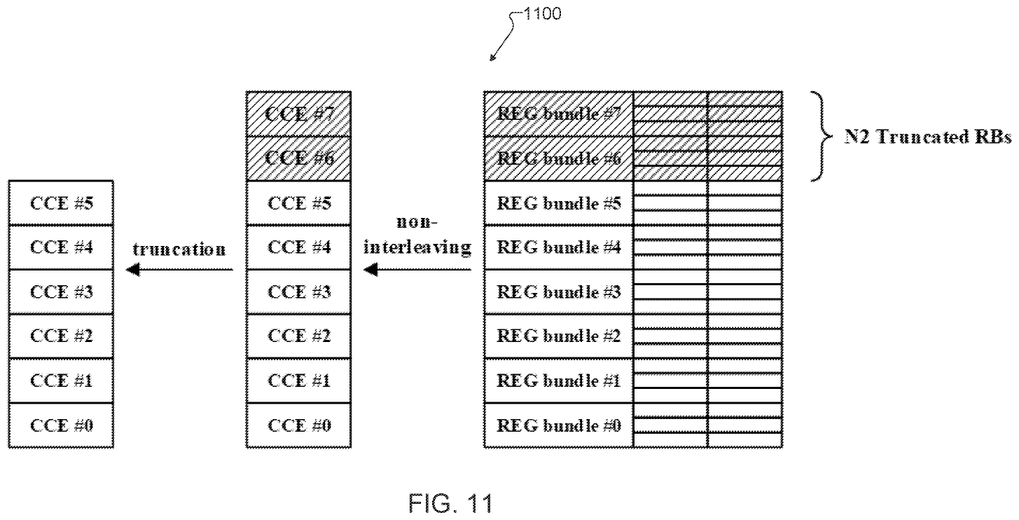

In one example, the CCE-to-REG mapping can be non-interleaved. The UE assumes f(x)=x when determining the REG bundles associated with a CCE, e.g., the CCE index and REG bundle index can be the same. In one instance for this example, the truncation of RBs from the highest RB, e.g., only CCEs with higher indexes are truncated, or N1=0. An illustration of this reordering is shown in FIG. 11.

FIG. 11 illustrates an example 1100 of no interleaving of CCEs according to embodiments of the present disclosure. The embodiment of no interleaving of CCEs of FIG. 11 is for illustration only. Different embodiments of no interleaving of CCEs could be used without departing from the scope of this disclosure.

Although FIG. 11 illustrates an example of 1100 of no interleaving of CCEs, various changes may be made to FIG. 11. For example, various changes to the CCEs, the REG bundles, the non-interleaving, etc. could be made according to particular needs.

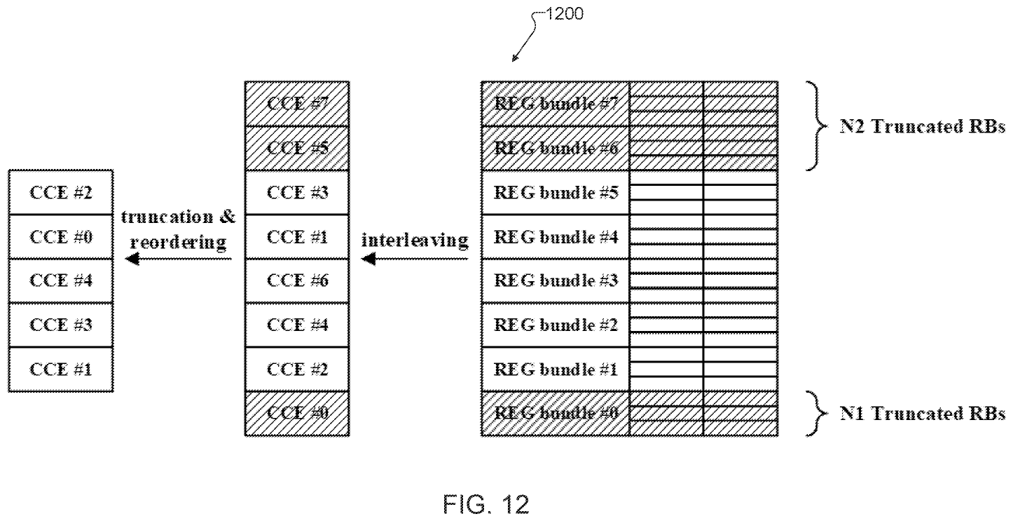

In another example, the CCE-to-REG mapping can maintain the same, but the CCEs are re-indexed after truncation of the CORESET bandwidth. For instance, a CCE #j before truncation can be determined as REG bundles {f(6j/L_REG), f(6j/L_REG+1), . . . , f(6j/L_REG+6/L_REG−1)} wherein f(·) is the interleaver, and the actual CCE index is determined as g(j), wherein g(·) is a reordering function, e.g., assuming the set of CCE indexes after truncation is S and the elements in S are ordered from lowest to highest, then g(j)+1 is the index of j in the set S (index starting from 1). An illustration of this reordering is shown in FIG. 12.

FIG. 12 illustrates an example 1200 of reordering of CCES after truncation according to embodiments of the present disclosure. The embodiment of reordering of CCES after truncation of FIG. 12 is for illustration only. Different embodiments of reordering of CCES after truncation could be used without departing from the scope of this disclosure.

Although FIG. 12 illustrates an example 1200 of reordering of CCES after truncation, various changes may be made to FIG. 1200. For example, various changes to the CCEs, the REG bundles, the interleaving, etc. could be made according to particular needs.

In yet another example, the CCE-to-REG mapping can be determined based on the truncated bandwidth of CORESET #0. For instance, when the UE is indicated with a CORESET #0 bandwidth (e.g., by indication in MIB), the UE truncates the CORESET #0 to a reduced bandwidth, and used the truncated bandwidth to determine the mapping pattern between CCE and REG bundle.

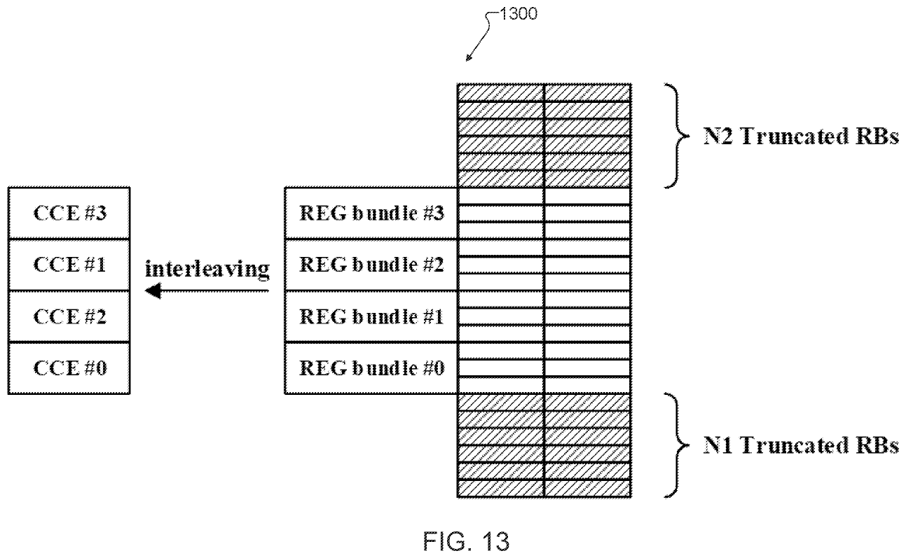

FIG. 13 illustrates an example 1300 of CCE-to-REG mapping using truncated bandwidth according to embodiments of the present disclosure. The embodiment of CCE-to-REG mapping using truncated bandwidth of FIG. 11 is for illustration only. Different embodiments of CCE-to-REG mapping using truncated bandwidth could be used without departing from the scope of this disclosure.

Although FIG. 13 illustrates an example of 1300 of CCE-to-REG mapping using truncated bandwidth, various changes may be made to FIG. 13. For example, various changes to the CCEs, the REG bundles, the interleaving, etc. could be made according to particular needs.

In one embodiment, enhancement to CCE selection for PDCCH candidates can be supported, e.g., for frequency band with minimum channel bandwidth smaller than 5 MHz (e.g., 3 MHz) or for a channel with channel bandwidth smaller than 5 MHz (e.g., 3 MHz). In one instance, this enhancement to CCE selection for PDCCH candidates is applicable to CORESET #0.

In one example, the CCE indexes for aggregation level L corre corresponding to PDCCH candidate m_{s,n}_{_{Cl}}^{(L)} of the search space set in slot n_{s,f}^{μ} for an active DL BWP of a serving cell corresponding to carrier indicator field value n_{Cl} can have an extra item n_{S} on top of the legacy equation, e.g.,

$$L \cdot \{ ( {y}_{p , {n}_{s , f}^{μ}} + ⌊ \frac{{m}_{s , {n}_{CI}}^{( L )} \cdot {N}_{CCP , p}}{L \cdot {M}_{s , m ax}^{( L )}} ⌋ + {n}_{CI} + {n}_{S} ) mod ⌊ {N}_{CCE , p} / L ⌋ \} + i$$

In one sub-example, nₛ can be physical cell ID, e.g., n_{S}=N_{ID}^{cell}.
In another sub-example, nₛ can correspond to the number of CCEs truncated from CORESET #0 from the lowest frequency, e.g., n_{S}=N1/(L_REG/N_symb).

In another example, the CCE indexes for aggregation level L corre corresponding to PDCCH candidate m_{s,n}_{_{Cl}}^{(L)} of the search space set in slot n_{s,f}^{μ} for an active DL BWP of a serving cell corresponding to carrier indicator field value n_{Cl} can be determined as

$$h ( L \cdot \{ ( {y}_{p , {n}_{s , f}^{μ}} + ⌊ \frac{{m}_{s , {n}_{CI}}^{( L )} \cdot {N}_{CCP , p}}{L \cdot {M}_{s , m ax}^{( L )}} ⌋ + {n}_{CI} + {n}_{S} ) mod ⌊ {N}_{CCE , p} / L ⌋ \} + i ) ,$$

wherein h(·) is a re-ordering function such that h(j) gives the value of the (j+1)th smallest element in set S, and set S is the set of CCE indexes after truncation of CORESET.

In one embodiment, at least one new PDCCH aggregation level can be supported, e.g., for frequency band with minimum channel bandwidth smaller than 5 MHz (e.g., 3 MHz) or for a channel with channel bandwidth smaller than 5 MHz (e.g., 3 MHz).

In one example, the at least one new PDCCH aggregation level can be supported for CORESET #0.

In another example, the at least one new PDCCH aggregation level can be aggregation level 6, which can consist of 6 CCEs.

In yet another example, the maximum number of PDCCH candidates corresponding to CCE AL 6, e.g., for Type0-PDCCH CSS sets, can be 1.
In one sub-example, the CCE aggregation levels and maximum number of PDCCH candidates per CCE aggregation level for CSS sets configured by searchSpaceSIB1 for frequency band with minimum channel bandwidth smaller than 5 MHz (e.g., 3 MHz) can be according to Table 34.
In another sub-example, the CCE aggregation levels and maximum number of PDCCH candidates per CCE aggregation level for CSS sets configured by searchSpaceSIB1 can be according to Table 35.

TABLE 34
Example CCE aggregation levels and maximum number of PDCCH
candidates per CCE aggregation level for CSS sets configured
by searchSpaceSIB1 for frequency band with minimum channel
bandwidth smaller than 5 MHz (e.g., 3 MHz).

| CCE Aggregation Level | Number of Candidates |
|---|---|
| 4 | 3 |
| 6 | 2 |
| 8 | 1 |

TABLE 35
Example CCE aggregation levels and maximum number
of PDCCH candidates per CCE aggregation level
for CSS sets configured by searchSpaceSIB1.

| CCE Aggregation Level | Number of Candidates |
|---|---|
| 4 | 4 |
| 6 | 2 |
| 8 | 2 |
| 16 | 1 |

In yet another example, the maximum number of PDCCH candidates corresponding to CCE AL 6, e.g., for Type0-PDCCH CSS sets, can be 1.
In one sub-example, the CCE aggregation levels and maximum number of PDCCH candidates per CCE aggregation level for CSS sets configured by searchSpaceSIB1 for a channel with channel bandwidth smaller than 5 MHz (e.g., 3 MHz) can be according to Table 36.
In another sub-example, the CCE aggregation levels and maximum number of PDCCH candidates per CCE aggregation level for CSS sets configured by searchSpaceSIB1 for a frequency band with minimum channel bandwidth smaller than 5 MHz (e.g., 3 MHz) can be according to Table 37.
In yet another sub-example, the CCE aggregation levels and maximum number of PDCCH candidates per CCE aggregation level for CSS sets configured by searchSpaceSIB1 can be according to Table 38.

TABLE 36
Example CCE aggregation levels and maximum number of
PDCCH candidates per CCE aggregation level for CSS
sets configured by searchSpaceSIB1 for a channel with
channel bandwidth smaller than 5 MHz (e.g., 3 MHz).

| CCE Aggregation Level | Number of Candidates |
|---|---|
| 4 | 2 |
| 6 | 1 |
| 8 | 1 |

TABLE 37
Example CCE aggregation levels and maximum number of PDCCH
candidates per CCE aggregation level for CSS sets configured
by searchSpaceSIB 1 for a frequency band with minimum
channel bandwidth smaller than 5 MHz (e.g., 3 MHz).

| CCE Aggregation Level | Number of Candidates |
|---|---|
| 4 | 3 |
| 6 | 1 |
| 8 | 1 |

TABLE 38
Example CCE aggregation levels and maximum number
of PDCCH candidates per CCE aggregation level
for CSS sets configured by searchSpaceSIB1.

| CCE Aggregation Level | Number of Candidates |
|---|---|
| 4 | 4 |
| 6 | 1 |
| 8 | 2 |
| 16 | 1 |

In one embodiment, a CORESET with 4 symbols can be supported, e.g., for a frequency band with minimum channel bandwidth smaller than 5 MHz (e.g., 3 MHz) or for a channel with channel bandwidth smaller than 5 MHz (e.g., 3 MHz).

In one example, the 4 symbol CORESET can be supported for CORESET #0.

In another example, when N_symb=4, L_REG=6.
In one sub-example, the parameter R in the interleaving function can be fixed as 2, and the value N_symb*N_RB can be an integer multiple of 12. For one instance, if a configuration includes N_symb=4, the associated number of RBs for CORESET #0 (e.g., N_RB) can be 15. For another instance, if a configuration includes N_symb=4, the associated number of RBs for CORESET #0 (e.g., N_RB) can be 12.
In another sub-example, the parameter R in the interleaving function can be fixed as 3, and the value N_symb*N_RB can be an integer multiple of 18. For one instance, if a configuration includes N_symb=4, the associated number of RBs for CORESET #0 (e.g., N_RB) can be 18.

In yet another example, when N_symb=4, L_REG=8.
In one sub-example, the parameter R in the interleaving function can be fixed as 3, and the value N_symb*N_RB can be an integer multiple of 24. For one instance, if a configuration includes N_symb=4, the associated number of RBs for CORESET #0 (e.g., N_RB) can be 12. For another instance, if a configuration includes N_symb=4, the associated number of RBs for CORESET #0 (e.g., N_RB) can be 18.
In another sub-example, the parameter R in the interleaving function can be fixed as 2, and the value N_symb*N_RB can be an integer multiple of 16. For one instance, if a configuration includes N_symb=4, the associated number of RBs for CORESET #0 (e.g., N_RB) can be 12. For another instance, if a configuration includes N_symb=4, the associated number of RBs for CORESET #0 (e.g., N_RB) can be 16.

In yet another example, when N_symb=4, L_REG=4.
In one sub-example, the parameter R in the interleaving function can be fixed as 3, and the value N_symb*N_RB can be an integer multiple of 12. For one instance, if a configuration includes N_symb=4, the associated number of RBs for CORESET #0 (e.g., N_RB) can be 12. For another instance, if a configuration includes N_symb=12, the associated number of RBs for CORESET #0 (e.g., N_RB) can be 15.
In another sub-example, the parameter R in the interleaving function can be fixed as 2, and the value N_symb*N_RB can be an integer multiple of 8. For one instance, if a configuration includes N_symb=4, the associated number of RBs for CORESET #0 (e.g., N_RB) can be 12. For another instance, if a configuration includes N_symb=14, the associated number of RBs for CORESET #0 (e.g., N_RB) can be 16.

In one embodiment, for a frequency band with minimum channel bandwidth smaller than 5 MHz (e.g., 3 MHz), or for a channel with channel bandwidth smaller than 5 MHz (e.g., 3 MHz), the maximum CCE aggregation level can be smaller than 16 for CSS sets configured by searchSpaceSIB1.

In one example, the maximum CCE aggregation level can be 8. For instance, the CCE aggregation levels and maximum number of PDCCH candidates per CCE aggregation level for CSS sets configured by searchSpaceSIB1 can be according to Table 39

TABLE 39
Example CCE aggregation levels and maximum number
of PDCCH candidates per CCE aggregation level
for CSS sets configured by searchSpaceSIB1.

| CCE Aggregation Level | Number of Candidates |
|---|---|
| 4 | 2 |
| 8 | 1 |

In another example, the maximum CCE aggregation level can be 4. For instance, the CCE aggregation levels and maximum number of PDCCH candidates per CCE aggregation level for CSS sets configured by searchSpaceSIB1 can be according to Table 40.

TABLE 40
Example CCE aggregation levels and maximum number
of PDCCH candidates per CCE aggregation level
for CSS sets configured by searchSpaceSIB1.

| CCE Aggregation Level | Number of Candidates |
|---|---|
| 4 | 1 |

In another embodiment, for a frequency band with minimum channel bandwidth smaller than 5 MHz (e.g., 3 MHz), or for a channel with channel bandwidth smaller than 5 MHz (e.g., 3 MHz), the parameters for PDCCH for in-sync and/or out-of-sync evaluation can be enhanced.

For one example, for SS/PBCH block based radio link monitoring, the PDCCH transmission parameters for out-of-sync evaluation can be according to Table 41.
For one sub-example, X1=3, X2=8, X3=4, X4=16.
For another sub-example, X1=2, X2=4, X3=7, X4=12.
For yet another sub-example, X1=2, X2=4, X3=4, X4=12.
For yet another sub-example, X1=3, X2=8, X3=4, X4=24.
For yet another sub-example, X1=2, X2=4, X3=7, X4=24.
For yet another sub-example, X1=2, X2=4, X3=4, X4=24.

TABLE 41
Example PDCCH transmission parameters
for out-of-sync evaluation.

| | Value for BLER |
|---|---|
| Attribute | Configuration #0 |
| DCI format | 1-0 |
| Number of control OFDM symbols | X1 |
| Aggregation level (CCE) | X2 |
| Ratio of hypothetical PDCCH RE energy | X3 dB |
| to average SSS RE energy | |
| Ratio of hypothetical PDCCH DMRS | X3 dB |
| energy to average SSS RE energy | |
| Bandwidth (PRBs) | X4 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

For another example, for SS/PBCH block based radio link monitoring, the PDCCH transmission parameters for in-sync evaluation can be according to Table 42.
For one sub-example, X1=2, X2=4, X3=0, X4=16.
For another sub-example, X1=2, X2=4, X3=0, X4=12.
For yet another sub-example, X1=2, X2=4, X3=3, X4=12.
For yet another sub-example, X1=3, X2=4, X3=0, X4=24.
For yet another sub-example, X1=2, X2=4, X3=3, X4=24.

TABLE 42
Example PDCCH transmission parameters for in-sync evaluation.

| | Value for BLER |
|---|---|
| Attribute | Configuration #0 |
| DCI format | 1-0 |
| Number of control OFDM symbols | X1 |
| Aggregation level (CCE) | X2 |
| Ratio of hypothetical PDCCH RE energy | X3 dB |
| to average SSS RE energy | |
| Ratio of hypothetical PDCCH DMRS | X3 dB |
| energy to average SSS RE energy | |
| Bandwidth (PRBs) | X4 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

For yet another example, for CSI-RS based radio link monitoring, the PDCCH transmission parameters for out-of-sync evaluation can be according to Table 43.

For one sub-example, X1=3, X2=8, X3=4, X4=16.
For another sub-example, X1=2, X2=4, X3=7, X4=12.
For yet another sub-example, X1=2, X2=4, X3=4, X4=12.
For yet another sub-example, X1=3, X2=8, X3=4, X4=48.
For yet another sub-example, X1=2, X2=4, X3=7, X4=48.
For yet another sub-example, X1=2, X2=4, X3=4, X4=48.

TABLE 43
Example PDCCH transmission parameters
for out-of-sync evaluation.

| | Value for BLER |
|---|---|
| Attribute | Configuration #0 |
| DCI format | 1-0 |
| Number of control OFDM symbols | X1 |
| Aggregation level (CCE) | X2 |
| Ratio of hypothetical PDCCH RE energy | X3 dB |
| to average SSS RE energy | |
| Ratio of hypothetical PDCCH DMRS | X3 dB |
| energy to average SSS RE energy | |
| Bandwidth (PRBs) | X4 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

For another example, for CSI-RS based radio link monitoring, the PDCCH transmission parameters for in-sync evaluation can be according to Table 44.
For one sub-example, X1=2, X2=4, X3=0, X4=16.
For another sub-example, X1=2, X2=4, X3=0, X4=12.
For yet another sub-example, X1=2, X2=4, X3=3, X4=12.
For yet another sub-example, X1=3, X2=4, X3=0, X4=48.
For yet another sub-example, X1=2, X2=4, X3=3, X4=48.

TABLE 44
Example PDCCH transmission parameters for in-sync evaluation.

| | Value for BLER |
|---|---|
| Attribute | Configuration #0 |
| DCI format | 1-0 |
| Number of control OFDM symbols | X1 |
| Aggregation level (CCE) | X2 |
| Ratio of hypothetical PDCCH RE energy | X3 dB |
| to average SSS RE energy | |
| Ratio of hypothetical PDCCH DMRS | X3 dB |
| energy to average SSS RE energy | |
| Bandwidth (PRBs) | X4 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

In yet another embodiment, for a frequency band with minimum channel bandwidth smaller than 5 MHz (e.g., 3 MHz), or for a channel with channel bandwidth smaller than 5 MHz (e.g., 3 MHz), the threshold associated with the requirement on radio link monitoring can be enhanced.

For one example, for SS/PBCH block based radio link monitoring, for a frequency band with minimum channel bandwidth smaller than 5 MHz (e.g., 3 MHz), or for a channel with channel bandwidth smaller than 5 MHz (e.g., 3 MHz), a UE shall be able to evaluate whether the downlink radio link quality on the configured RLM-RS resource estimated over the last T_Evaluate_out_SSB [ms] period becomes worse than the threshold Q′_out_SSB within T_Evaluate_out_SSB [ms] evaluation period. For one instance, Q′_out_SSB=Q_out_SSB−3 dB. For another instance, Q′ out_SSB=Q_out_SSB+3 dB.

For another example, for SS/PBCH block based radio link monitoring, for a frequency band with minimum channel bandwidth smaller than 5 MHz (e.g., 3 MHz), or for a channel with channel bandwidth smaller than 5 MHz (e.g., 3 MHz), a UE shall be able to evaluate whether the downlink radio link quality on the configured RLM-RS resource estimated over the last T_Evaluate_out_SSB [ms] period becomes better than the threshold Q′_in_SSB within T_Evaluate_out_SSB [ms] evaluation period. For one instance, Q′_in_SSB=Q_in_SSB−3 dB. For another instance, Q′ in SSB=Q in SSB+3 dB.

For yet another example, for SS/PBCH block based relaxed radio link monitoring, for a frequency band with minimum channel bandwidth smaller than 5 MHz (e.g., 3 MHz), or for a channel with channel bandwidth smaller than 5 MHz (e.g., 3 MHz), a UE shall be able to evaluate whether the downlink radio link quality on the configured RLM-RS resource estimated over the last T_Evaluate_out_SSB_Relax [ms] period becomes worse than the threshold Q′_out_SSB within T_Evaluate_out_SSB_Relax [ms] evaluation period. For one instance, Q′_out_SSB=Q_out_SSB−3 dB. For another instance, Q′_out_SSB=Q_out_SSB+3 dB.

For one example, for CSI-RS based radio link monitoring, for a frequency band with minimum channel bandwidth smaller than 5 MHz (e.g., 3 MHz), or for a channel with channel bandwidth smaller than 5 MHz (e.g., 3 MHz), a UE shall be able to evaluate whether the downlink radio link quality on the configured RLM-RS resource estimated over the last T_Evaluate_out_CSI-RS [ms] period becomes worse than the threshold Q′_out_CSI-RS within T_Evaluate_out_CSI-RS [ms] evaluation period. For one instance, Q′_out_CSI-RS=Q_out_CSI-RS−3 dB. For another instance, Q′_out_SSB=Q_out_SSB+3 dB.

For another example, for CSI-RS based radio link monitoring, for a frequency band with minimum channel bandwidth smaller than 5 MHz (e.g., 3 MHz), or for a channel with channel bandwidth smaller than 5 MHz (e.g., 3 MHz), a UE shall be able to evaluate whether the downlink radio link quality on the configured RLM-RS resource estimated over the last T_Evaluate_out_CSI-RS [ms] period becomes better than the threshold Q′_in_CSI-RS within T_Evaluate_out_CSI-RS [ms] evaluation period. For one instance, Q′_in_CSI-RS=Q_in_CSI-RS−3 dB. For another instance, Q′_in_SSB=Q in SSB+3 dB.

For yet another example, for CSI-RS based relaxed radio link monitoring, for a frequency band with minimum channel bandwidth smaller than 5 MHz (e.g., 3 MHz), or for a channel with channel bandwidth smaller than 5 MHz (e.g., 3 MHz), a UE shall be able to evaluate whether the downlink radio link quality on the configured RLM-RS resource estimated over the last T_Evaluate_out_CSI-RS_Relax [ms] period becomes worse than the threshold Q′_out_CSI-RS within T_Evaluate_out_CSI-RS_Relax [ms] evaluation period. For one instance, Q′_out_CSI-RS=Q_out_CSI-RS−3 dB. For another instance, Q′ out SSB=Q out SSB+3 dB.

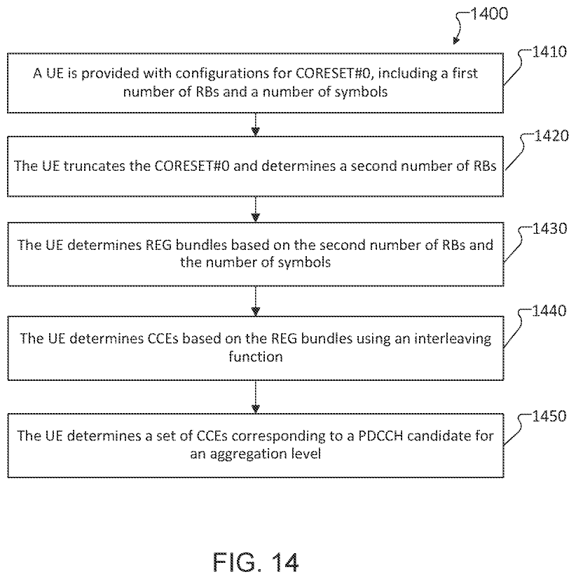

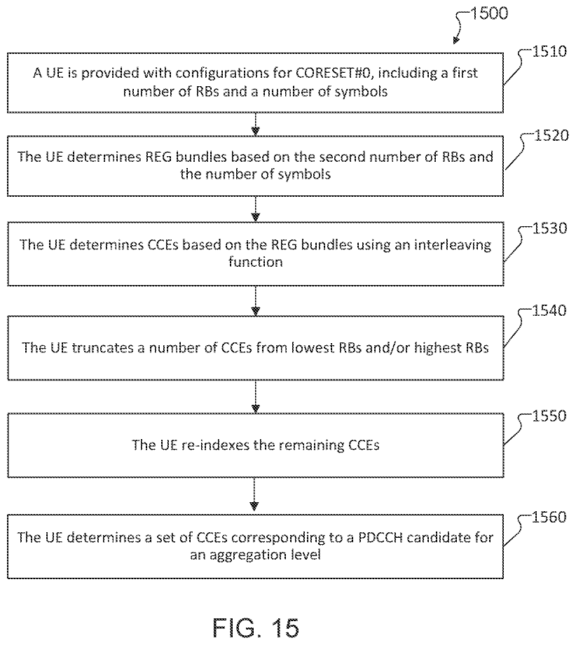

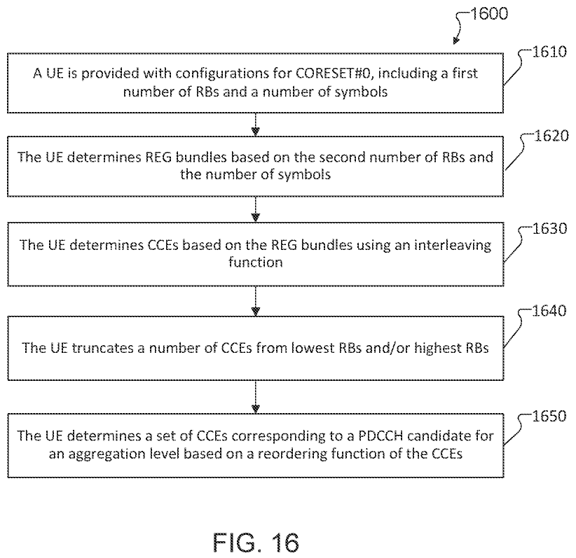

In one embodiment, an example UE procedure for determining the CCEs for CORESET #0 and CCEs for PDCCH candidates is shown in FIG. 14, or FIG. 15, or FIG. 16.

FIG. 14 illustrates a UE procedure 1400 for determining the CCEs for CORESET #0 and CCEs for PDCCH candidates according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of adaptive beamforming could be used without departing from the scope of this disclosure.

As illustrated in FIG. 14, the method 1400 begins at step 1410. At step 1410, a UE is provided with configurations for CORESET #0, including a first number of RBs and a number of symbols. At step 1420, the UE truncates the CORESET #0 and determines a second number of RBs. At step 1430, the UE determines REG bundles based on the second number of RBs and the number of symbols. At step 1440, the UE determines CCEs based on the REG bundles using an interleaving function. Finally, at step 1460, the UE determines a set of CCEs corresponding to a PDCCH candidate for an aggregation level.

Although FIG. 14 illustrates one example of a UE procedure 1400 for determining the CCEs for CORESET #0 and CCEs for PDCCH candidates, various changes may be made to FIG. 14. For example, while shown as a series of steps, various steps in FIG. 14 could overlap, occur in parallel, occur in a different order, or occur any number of times.

FIG. 15 illustrates a UE procedure 1500 for determining the CCEs for CORESET #0 and CCEs for PDCCH candidates according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of adaptive beamforming could be used without departing from the scope of this disclosure.

As illustrated in FIG. 15, the method 1500 begins at step 1510. At step 1510, a UE is provided with configurations for CORESET #0, including a first number of RBs and a number of symbols. At step 1520, the UE determines REG bundles based on the second number of RBs and the number of symbols. At step 1530, the UE determines CCEs based on the REG bundles using an interleaving function. At step 1540, the UE truncates a number of CCEs from lowest RBs and/or highest RBs. At step 1550, the UE re-indexes the remaining CCEs. Finally, at step 1560, the UE determines a set of CCEs corresponding to a PDCCH candidate for an aggregation level.

Although FIG. 15 illustrates one example of a UE procedure 1500 for determining the CCEs for CORESET #0 and CCEs for PDCCH candidates, various changes may be made to FIG. 15. For example, while shown as a series of steps, various steps in FIG. 15 could overlap, occur in parallel, occur in a different order, or occur any number of times.

FIG. 16 illustrates a UE procedure 1600 for determining the CCEs for CORESET #0 and CCEs for PDCCH candidates according to embodiments of the present disclosure. An embodiment of the method illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of adaptive beamforming could be used without departing from the scope of this disclosure.

As illustrated in FIG. 16, the method 1600 begins at step 1610. At step 1610, a UE is provided with configurations for CORESET #0, including a first number of RBs and a number of symbols. At step 1620, the UE determines REG bundles based on the second number of RBs and the number of symbols. At step 1630, the UE determines CCEs based on the REG bundles using an interleaving function. At step 1640, the UE truncates a number of CCEs from lowest RBs and/or highest RBs. Finally, at step 1660, the UE determines a set of CCEs corresponding to a PDCCH candidate for an aggregation level based on a reordering function of the CCEs.

Although FIG. 16 illustrates one example of a UE procedure 1600 for determining the CCEs for CORESET #0 and CCEs for PDCCH candidates, various changes may be made to FIG. 16. For example, while shown as a series of steps, various steps in FIG. 16 could overlap, occur in parallel, occur in a different order, or occur any number of times.

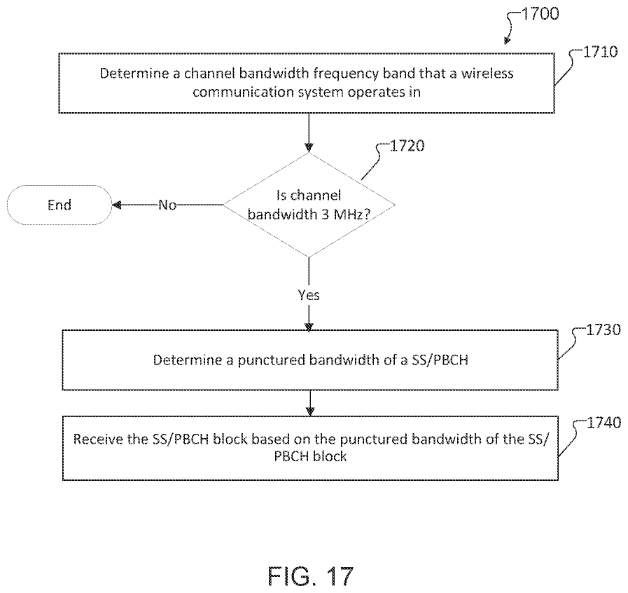

FIG. 17 illustrates a UE procedure 1700 for determining a punctured bandwidth of a SS/PBCH according to embodiments of the present disclosure. An embodiment of the method illustrated in FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments of adaptive beamforming could be used without departing from the scope of this disclosure.

As illustrated in FIG. 17, the method 1700 begins at step 1710. At step 1710, a UE determines a channel bandwidth frequency for a frequency band that a wireless communication system operates in. At step 1720, the UE determines if the channel bandwidth is 3 MHz. If the channel bandwidth is 3 MHz, then at step 1730, the UE determines a punctured bandwidth of a SS/PBCH. In one embodiment, subcarriers 0 to 47 and subcarriers 192 to 239 are punctured from 240 subcarriers of the SS/PBCH block bandwidth, and all 4 symbols of the SS/PBCH block are punctured. Finally, at step 1740, the UE receives the SS/PBCH block based on the punctured bandwidth of the SS/PBCH block.

Although FIG. 17 illustrates one example of a UE procedure 1700 for determining a punctured bandwidth of a SS/PBCH, various changes may be made to FIG. 17. For example, while shown as a series of steps, various steps in FIG. 17 could overlap, occur in parallel, occur in a different order, or occur any number of times.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) in a wireless communication system, the UE comprising:
a processor configured to:
determine a channel bandwidth for a frequency band in which the wireless communication system operates, and
when the channel bandwidth is 3 megahertz (MHz), determine a punctured bandwidth of a synchronization signals and physical broadcast channel (SS/PBCH) block as 144 subcarriers, wherein:
subcarriers 0 to 47 and subcarriers 192 to 239 are punctured from 240 subcarriers of the SS/PBCH block bandwidth, and
all 4 symbols of the SS/PBCH block are punctured; and
a transceiver operably coupled to the processor, the transceiver configured to receive the SS/PBCH block based on the punctured bandwidth of the SS/PBCH block.

2. The UE of claim 1, wherein:
the processor is further configured to determine a set of configurations for a control resource set #0 (CORESET #0) based on a subcarrier spacing (SCS) of the SS/PBCH block, a SCS of the CORESET #0, a minimum channel bandwidth of the frequency band, and the channel bandwidth; and
the set of configurations for the CORESET #0 are determined from:
a first table, when the SCS of the SS/PBCH block is 15 kHz, the SCS of the CORESET #0 is 15 kHz, the minimum channel bandwidth of the frequency band is 3 MHz, and the channel bandwidth is 3 MHz or 5 MHz; or
a second table, when the SCS of the SS/PBCH block is 15 kHz, the SCS of the CORESET #0 is 15 kHz, the minimum channel bandwidth of the frequency band is 3 MHz, and the channel bandwidth is 5 MHz or larger.

3. The UE of claim 2, wherein:
when the SCS of the SS/PBCH block is 15 kHz, the SCS of the CORESET #0 is 15 kHz, the minimum channel bandwidth of the frequency band is 3 MHz, and the channel bandwidth is 5 MHz, the set of configurations for the CORESET #0 is determined from:
the first table, when a frequency location of the SS/PBCH block is selected from a first set of synchronization raster entries; or
the second table, when the frequency location of the SS/PBCH block is selected from a second set of synchronization raster entries; and
the first set and the second set of synchronization raster entries do not overlap.

4. The UE of claim 2, wherein the set of configurations for the CORESET #0 include:
a multiplexing pattern between the SS/PBCH block and the CORESET #0;
a number of resource blocks (RBs) for the CORESET #0;
a number of symbols for the CORESET #0; and
an offset in a unit of RB s, where the offset is from a smallest RB index of the CORESET #0 to a smallest RB index of a common RB overlapping with a first RB of the SS/PBCH block after puncturing, when the bandwidth of the SS/PBCH block is punctured to 144 subcarriers.

5. The UE of claim 4, wherein the first table is given by:

| | Multiplexing | | | |
|---|---|---|---|---|
| | pattern | Number of | | |
| | between the | resource | Number of | |
| | SS/PBCH block | blocks (RBs) | symbols | |
| | and the | for the | for the | Offset |
| Index | CORESET#0 | CORESET#0 | CORESET#0 | (RBs) |
| 0 | 1 | 12 | 2 | 0 |
| 1 | 1 | 12 | 3 | 0 |
| 2 | 1 | 24 | 2 | 0 |
| 3 | 1 | 24 | 2 | 2 |
| 4 | 1 | 24 | 3 | 0 |
| 5 | 1 | 24 | 3 | 2 |
| 6 | 1 | 24 | 2 | 0 |
| 7 | 1 | 24 | 2 | 2 |
| 8 | 1 | 24 | 3 | 0 |
| 9 | 1 | 24 | 3 | 2 |
| 10 | 1 | 24 | 2 | 0 |
| 11 | 1 | 24 | 3 | 0 |
| | |
|---|---|
| 12 | Reserved |
| 13 | Reserved |
| 14 | Reserved |
| 15 | Reserved |

6. The UE of claim 5, wherein for the configurations with index 6 to 9, non-interleaved control channel element to resource element group (CCE-to-REG) mapping is applied.

7. The UE of claim 5, wherein
for the configurations with index 2 to 9, the number of RBs for the CORESET #0 are punctured from 24 to 15, by puncturing highest 9 RBs, after applying a CCE-to-REG mapping; and
for the configurations with index 10 to 11, the number of RBs for the CORESET #0 are punctured from 24 to 10, by puncturing highest 4 RBs, after applying the CCE-to-REG mapping.

8. A base station (BS) in a wireless communication system, the BS comprising:
a processor configured to:
determine a channel bandwidth for a frequency band in which the wireless communication system operates, and
when the channel bandwidth is 3 megahertz (MHz), determine a punctured bandwidth of a synchronization signals and physical broadcast channel (SS/PBCH) block as 144 subcarriers, wherein:
subcarriers 0 to 47 and subcarriers 192 to 239 are punctured from 240 subcarriers of the SS/PBCH block bandwidth, and
all 4 symbols of the SS/PBCH block are punctured; and
a transceiver operably coupled to the processor, the transceiver configured to transmit the SS/PBCH block based on the punctured bandwidth of the SS/PBCH block.

9. The BS of claim 8, wherein:
the processor is further configured to determine a set of configurations for a control resource set #0 (CORESET #0) based on a subcarrier spacing (SCS) of the SS/PBCH block, a SCS of the CORESET #0, a minimum channel bandwidth of the frequency band, and the channel bandwidth; and
the set of configurations for the CORESET #0 are determined from:
a first table, when the SCS of the SS/PBCH block is 15 kHz, the SCS of the CORESET #0 is 15 kHz, the minimum channel bandwidth of the frequency band is 3 MHz, and the channel bandwidth is 3 MHz or 5 MHz; or
a second table, when the SCS of the SS/PBCH block is 15 kHz, the SCS of the CORESET #0 is 15 kHz, the minimum channel bandwidth of the frequency band is 3 MHz, and the channel bandwidth is 5 MHz or larger.

10. The BS of claim 9, wherein:
when the SCS of the SS/PBCH block is 15 kHz, the SCS of the CORESET #0 is 15 kHz, the minimum channel bandwidth of the frequency band is 3 MHz, and the channel bandwidth is 5 MHz, the set of configurations for the CORESET #0 is determined from:
the first table, when a frequency location of the SS/PBCH block is selected from a first set of synchronization raster entries; or
the second table, when the frequency location of the SS/PBCH block is selected from a second set of synchronization raster entries; and
the first set and the second set of synchronization raster entries do not overlap.

11. The BS of claim 9, wherein the set of configurations for the CORESET #0 include:
a multiplexing pattern between the SS/PBCH block and the CORESET #0;
a number of resource blocks (RBs) for the CORESET #0;
a number of symbols for the CORESET #0; and
an offset in a unit of RB s, where the offset is from a smallest RB index of the CORESET #0 to a smallest RB index of a common RB overlapping with a first RB of the SS/PBCH block after puncturing, when the bandwidth of the SS/PBCH block is punctured to 144 subcarriers.

12. The BS of claim 11, wherein the first table is given by:

| | Multiplexing | | | |
|---|---|---|---|---|
| | pattern | Number of | | |
| | between the | resource | Number of | |
| | SS/PBCH block | blocks (RBs) | symbols | |
| | and the | for the | for the | Offset |
| Index | CORESET#0 | CORESET#0 | CORESET#0 | (RBs) |
| 0 | 1 | 12 | 2 | 0 |
| 1 | 1 | 12 | 3 | 0 |
| 2 | 1 | 24 | 2 | 0 |
| 3 | 1 | 24 | 2 | 2 |
| 4 | 1 | 24 | 3 | 0 |
| 5 | 1 | 24 | 3 | 2 |
| 6 | 1 | 24 | 2 | 0 |
| 7 | 1 | 24 | 2 | 2 |
| 8 | 1 | 24 | 3 | 0 |
| 9 | 1 | 24 | 3 | 2 |
| 10 | 1 | 24 | 2 | 0 |
| 11 | 1 | 24 | 3 | 0 |
| | |
|---|---|
| 12 | Reserved |
| 13 | Reserved |
| 14 | Reserved |
| 15 | Reserved |

13. The BS of claim 12, wherein for the configurations with index 6 to 9, non-interleaved control channel element to resource element group (CCE-to-REG) mapping is applied.

14. The BS of claim 12, wherein:
for the configurations with index 2 to 9, the number of RBs for the CORESET #0 are punctured from 24 to 15, by puncturing highest 9 RBs, after applying a CCE-to-REG mapping; and
for the configurations with index 10 to 11, the number of RBs for the CORESET #0 are punctured from 24 to 10, by puncturing highest 4 RBs, after applying the CCE-to-REG mapping.

15. A method of a user equipment (UE) in a wireless communication system, the method comprising:
determining a channel bandwidth for a frequency band in which the wireless communication system operates, and
when the channel bandwidth is 3 megahertz (MHz), determining a punctured bandwidth of a synchronization signals and physical broadcast channel (SS/PBCH) block as 144 subcarriers, wherein:
subcarriers 0 to 47 and subcarriers 192 to 239 are punctured from 240 subcarriers of the SS/PBCH block bandwidth, and
all 4 symbols of the SS/PBCH block are punctured; and
receiving the SS/PBCH block based on the punctured bandwidth of the SS/PBCH block.

16. The method of claim 15 further comprising:
determining a set of configurations for a control resource set #0 (CORESET #0) based on a subcarrier spacing (SCS) of the SS/PBCH block, a SCS of the CORESET #0, a minimum channel bandwidth of the frequency band, and the channel bandwidth,
wherein the set of configurations for the CORESET #0 are determined from:
a first table, when the SCS of the SS/PBCH block is 15 kHz, the SCS of the CORESET #0 is 15 kHz, the minimum channel bandwidth of the frequency band is 3 MHz, and the channel bandwidth is 3 MHz or 5 MHz; or
a second table, when the SCS of the SS/PBCH block is 15 kHz, the SCS of the CORESET #0 is 15 kHz, the minimum channel bandwidth of the frequency band is 3 MHz, and the channel bandwidth is 5 MHz or larger.

17. The method of claim 16, wherein:
when the SCS of the SS/PBCH block is 15 kHz, the SCS of the CORESET #0 is 15 kHz, the minimum channel bandwidth of the frequency band is 3 MHz, and the channel bandwidth is 5 MHz, the set of configurations for the CORESET #0 is determined from:
the first table, when a frequency location of the SS/PBCH block is selected from a first set of synchronization raster entries; or
the second table, when the frequency location of the SS/PBCH block is selected from a second set of synchronization raster entries; and
the first set and the second set of synchronization raster entries do not overlap.

18. The method of claim 16, wherein the set of configurations for the CORESET #0 include:
a multiplexing pattern between the SS/PBCH block and the CORESET #0;
a number of resource blocks (RBs) for the CORESET #0;
a number of symbols for the CORESET #0; and
an offset in a unit of RB s, where the offset is from a smallest RB index of the CORESET #0 to a smallest RB index of a common RB overlapping with a first RB of the SS/PBCH block after puncturing, when the bandwidth of the SS/PBCH block is punctured to 144 subcarriers.

19. The method of claim 18, wherein the first table is given by:

| | Multiplexing | | | |
|---|---|---|---|---|
| | pattern | Number of | | |
| | between the | resource | Number of | |
| | SS/PBCH block | blocks (RBs) | symbols | |
| | and the | for the | for the | Offset |
| Index | CORESET#0 | CORESET#0 | CORESET#0 | (RBs) |
| 0 | 1 | 12 | 2 | 0 |
| 1 | 1 | 12 | 3 | 0 |
| 2 | 1 | 24 | 2 | 0 |
| 3 | 1 | 24 | 2 | 2 |
| 4 | 1 | 24 | 3 | 0 |
| 5 | 1 | 24 | 3 | 2 |
| 6 | 1 | 24 | 2 | 0 |
| 7 | 1 | 24 | 2 | 2 |
| 8 | 1 | 24 | 3 | 0 |
| 9 | 1 | 24 | 3 | 2 |
| 10 | 1 | 24 | 2 | 0 |
| 11 | 1 | 24 | 3 | 0 |
| | |
|---|---|
| 12 | Reserved |
| 13 | Reserved |
| 14 | Reserved |
| 15 | Reserved |

20. The method of claim 19, wherein:
for the configurations with index 6 to 9, non-interleaved control channel element to resource element group (CCE-to-REG) mapping is applied;
for the configurations with index 2 to 9, the number of RBs for the CORESET #0 are punctured from 24 to 15, by puncturing highest 9 RBs, after applying a CCE-to-REG mapping; and
for the configurations with index 10 to 11, the number of RBs for the CORESET #0 are punctured from 24 to 10, by puncturing highest 4 RBs, after applying the CCE-to-REG mapping.
